(19) United States
(12) Patent Application Publication
(10) Pub. No.: US 2024/0326011 A1
(43) Pub. Date: Oct. 3, 2024

(54) MEMBRANE-COATED FRAMEWORKS FOR CONTROLLING GAS SORPTION

(71) Applicants: Alliance for Sustainable Energy, LLC, Golden, CO (US); Colorado School of Mines, Golden, CO (US)

(72) Inventors: Wade Adam BRAUNECKER, Lafayette, CO (US); Thomas GENNETT, Denver, CO (US); Rachel Elizabeth MOW, Boulder, CO (US); Sarah Marie SHULDA, Golden, CO (US)

(21) Appl. No.: 18/595,122

(22) Filed: Mar. 4, 2024

Related U.S. Application Data
(60) Provisional application No. 63/488,061, filed on Mar. 2, 2023.

(51) Int. Cl. B01J 20/22; B01J 20/26; B01J 20/28; B01J 20/32

(52) U.S. Cl. CPC B01J 20/226; B01J 20/264; B01J 20/28007; B01J 20/28016; B01J 20/28061; B01J 20/2808; B01J 20/28083; B01J 20/3206; B01J 20/3219; B01J 20/3272; B01J 20/3293

(57) ABSTRACT

The present disclosure relates to a composition that includes a covalent organic framework (COF) having an internal volume and an outer surface and a first polymer covalently bonded to at least a portion of the outer surface, where the covalently bonded first polymer has a glass transition temperature (T_{g}) between about −130° C. and about +180° C., the composition is capable of reversibly adsorbing and desorbing H₂ when the composition is at a temperature greater than or equal to the T_{g}, and the composition is capable of storing H₂ within the internal volume when the composition is at a temperature less than T_{g}.

### CROSS-REFERENCE TO RELATED APPLICATIONS

This application claims priority from U.S. Provisional Patent Application No. 63/488,061 filed on Mar. 2, 2023, the contents of which are incorporated herein by reference in the entirety.

### CONTRACTUAL ORIGIN

This invention was made with government support under Contract No. DE-AC36-08GO28308 awarded by the Department of Energy. The government has certain rights in the invention.

### BACKGROUND

Solid, porous materials such as zeolites, porous carbons, metal organic frameworks (MOFs), and covalent organic frameworks (COFs) are promising materials for applications ranging from biomedicine to energy storage, catalysis, gas storage, and separations. COFs are of particular interest gas storage given their low densities, high surface areas, and excellent tunability. However, the wide-scale applicability of COF powders for storage applications has generally been limited by their poor packing densities, low thermal conductivities, and relatively weak interactions with gases like H₂ that necessitate cryogenic storage temperatures to achieve appreciable capacities. Thus, there remains a need for improved framework compositions capable of reversibly storing H₂ and other gases at conditions reasonable for large scale use.

### SUMMARY

An aspect of the present disclosure is a composition that includes a covalent organic framework (COF) having an internal volume and an outer surface and a first polymer covalently bonded to at least a portion of the outer surface, where the covalently bonded first polymer has a glass transition temperature (T_{g}) between about −130° C. and about +180° C., the composition is capable of reversibly adsorbing and desorbing H₂ when the composition is at a temperature greater than or equal to the T_{g}, and the composition is capable of storing H₂ within the internal volume when the composition is at a temperature less than T_{g}. In some embodiments of the present disclosure, the COF may include a chelated first row transition metal (Mt) that includes at least one of Sc, Ti, V, Cr, Mn, Fe, Co, Ni, Cu, and/or Zn.

In some embodiments of the present disclosure, the COF may include a first structure that includes at least one of

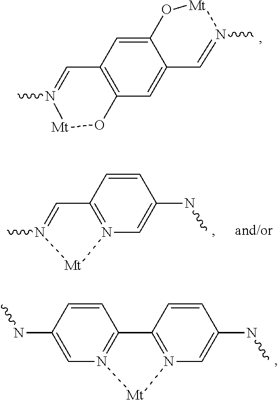

and where [symbol] represents a covalent bond.

In some embodiments of the present disclosure, the COF may include a second structure that includes at least one of

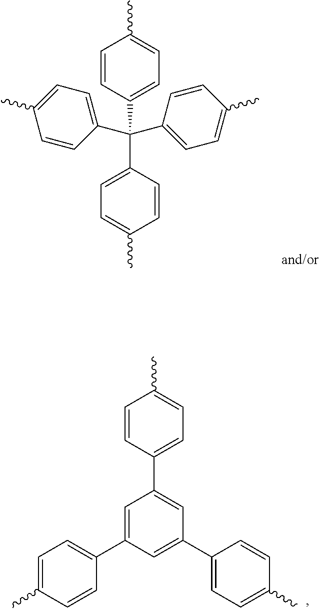

In some embodiments of the present disclosure, the first polymer may include at least one of an alkyl chain, a siloxane, and/or an ethylene oxide group. In some embodiments of the present disclosure, the first polymer may include at least one of a poly(alkyl acrylate), a poly(alkyl methacrylate), a polydimethylsiloxane acrylate, a polydimethylsiloxane methacrylate, a polyethylene glycol acrylate, and/or a polyethylene glycol methacrylate.

In some embodiments of the present disclosure, the composition includes a third structure

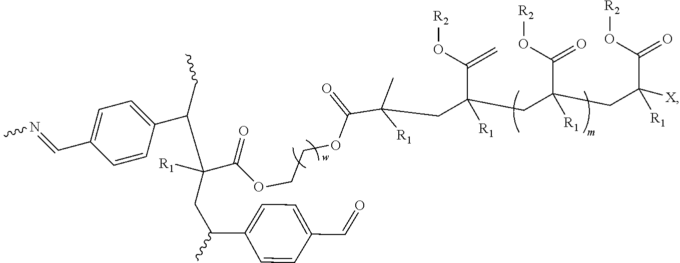

where w is between 0 and 20, inclusively, m is between 1 and 500, inclusively, X includes a halogen, R₁ includes a methyl group or H, and R₂ includes at least one of an alkyl chain, a siloxane, and/or an ethylene oxide group. In some embodiments of the present disclosure, R₂ may include at least one of

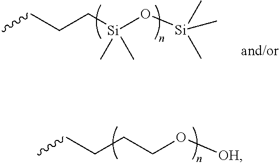

and n is between 1 and 500, inclusively. In some embodiments of the present disclosure, the composition may further include a fourth structure

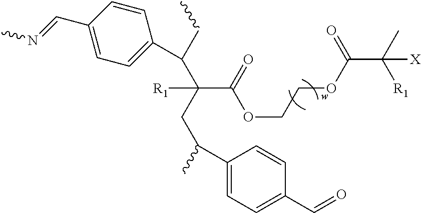

where w is between 0 and 20, inclusively, X includes at least one of Cl, Br, or I, and R₁ includes a methyl group or H.

In some embodiments of the present disclosure, the COF may have an average pore size between about 1 Å and about 40 Å. In some embodiments of the present disclosure, the COF may have an average surface area above about 400 m²/g. In some embodiments of the present disclosure, the COF may form a particle having an average diameter between about 10 nm and about 10 μm. In some embodiments of the present disclosure, the COF may have an H₂ loading above about 0.01 g H₂/g.

In some embodiments of the present disclosure, the composition may further include a second polymer that include at least one of a polydimethylsiloxane, a polyethyleneimine, a polyethylene glycol, a poly(alkyl acrylate), and/or a poly(alkyl methacrylate), where the COF is immersed in the second polymer, and the second polymer is characterized by a second T_{g} between about −130° C. and about +180° C.

An aspect of the present disclosure is a composition that includes a metal organic framework (MOF) having an internal volume and an outer surface and a first polymer covalently bonded to at least a portion of the outer surface, where the covalently bonded first polymer has a glass transition temperature (T_{g}) between about-130° C. and about +180° C., the composition is capable of reversibly adsorbing and desorbing H₂ when the composition is at a temperature greater than or equal to the T_{g}, and the composition is capable of storing H₂ within the internal volume when the composition is at a temperature less than T_{g}.

In some embodiments of the present disclosure, the MOF may include a first structure that includes at least one of

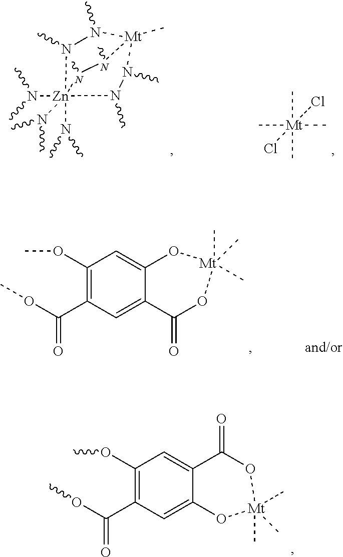

[symbol]

represents a covalent bond, and [symbol] represents a coordinate bond to Mt.

In some embodiments of the present disclosure, the MOF may include a second structure that includes at least one of

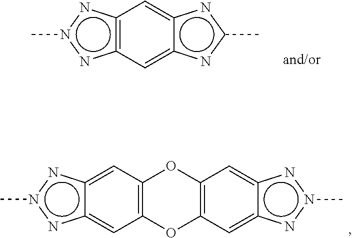

and [symbol] represents a coordinate bond to Mt.

In some embodiments of the present disclosure, the composition includes a third structure

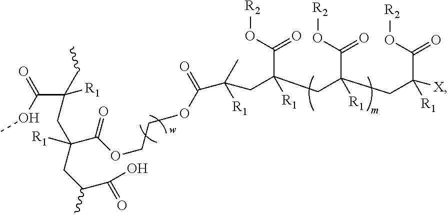

where w is between 0 and 20, inclusively, m is between 1 and 500, inclusively, X includes a halogen, R₁ includes a methyl group or H, and R₂ includes at least one of an alkyl chain, a siloxane, and/or an ethylene oxide group.

In some embodiments of the present disclosure, the composition may further include a fourth structure

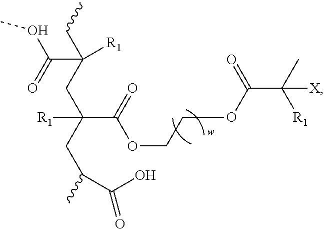

where w is between 0 and 20, inclusively, X includes at least one of Cl, Br, and/or I, and R₁ comprises a methyl group or H.

An aspect of the present disclosure is a method for making a composition, where the method includes synthesizing a framework material, synthesizing a first polymer, synthesizing a bifunctional linking polymer, attaching the bifunctional linking polymer to a surface of the framework material, and attaching a first polymer to the bifunctional linking polymer.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a size distribution of uncoated COF colloids, according to some embodiments of the present disclosure.

FIG. 2 illustrates XRD data of semi-crystalline COF colloids, revealing a small structural change associated with a polydimethylsiloxane (PDMS) coating, and minimal structural changes upon Cu-loading, according to some embodiments of the present disclosure.

FIG. 3 illustrates an N₂ isotherm of uncoated COF-301 colloids, according to some embodiments of the present disclosure.

FIG. 4 illustrates pore size distribution data of uncoated COF-301 colloids, according to some embodiments of the present disclosure.

FIGS. 5A and 5B illustrate a dual functional copolymer synthesized with benzaldehyde “anchoring” sites and 2-bromoisobutyryloxy “initiating” sites, according to some embodiments of the present disclosure. After bonding the copolymer to COF colloids through a surface condensation reaction, a polydimethylsiloxane-methacryalte (PDMS-MA) membrane was grown around the COF using atom transfer radical polymerization (ATRP).

FIGS. 5C and 5D a synthetic route for synthesize a coated MOF, according to some embodiments of the present disclosure.

FIG. 6A illustrates differential scanning calorimetry (DSC) data of neat PDMS, according to some embodiments of the present disclosure.

FIG. 6B illustrates DSC data of PDMS containing 10 wt. % crosslinker, according to some embodiments of the present disclosure.

FIG. 7A illustrates normalized detector response for PDMS-MA, according to some embodiments of the present disclosure.

FIG. 7B illustrates PDMS-MA molecular weight as a function of time, according to some embodiments of the present disclosure. Conditions: 200:1:2:2 PDMS-MA:EBriB:CuCl:Me₆TREN, room temperature, 10/90 mixture of acetonitrile/dioxane. Conversion estimated from NMR.

FIG. 7C illustrates PDMS-MA conversion as a function of time, according to some embodiments of the present disclosure. Conditions: 200:1:2:2 PDMS-MA:EBriB:CuCl:Me₆TREN, room temperature, 10/90 mixture of acetonitrile/dioxane. Conversion estimated from NMR.

FIG. 8 illustrates PDMS-MA molecular weight as a function of time and conversion, according to some embodiments of the present disclosure. Conditions: 20:1:2:2 PDMS-MA:EBriB:CuCl:Me₆TREN, room temperature, 10/90 mixture of acetonitrile/dioxane. Conversion estimated from NMR.

FIGS. 9A-9F illustrate various embodiments of the present disclosure: TEM images showing the dispersion of COF-301@PDMS-MA particles following (FIG. 9A) their initial synthesis and (FIG. 9B) after the addition of Cu, several purification cycles, drying, and resuspension. (FIG. 9C) Sacrificial initiator was used in the synthesis of COF-301@1 thin’ PDMS-MA and COF-301@‘thick’ PDMS-MA; black and red size exclusion chromatography traces for samples taken from the ‘thin’ and ‘thick’ coating reactions, respectively. EDS mapping for Si (Column 1), O (Column 2), N (Column 3), C (Column 4), and Cu (Column 5) for COF-301@PDMS-MA with (FIG. 9D) ‘thin’ coating, (FIG. 9E) ‘thick’ coating, and (FIG. 9F) ‘thin’ coating following the addition of Cu(II)formate. Note the different length scale bars in FIGS. 9D, 9E, and 9F.

FIG. 10 illustrates CO₂ isotherms on the uncoated colloidal COF-301 and COF-301@xPDMS, where the “x” refers to cross-linked PDMS, according to some embodiments of the present disclosure.

FIG. 11 illustrates attenuated total reflectance (ATR) spectra of Cu-COF-301@PDMS, according to some embodiments of the present disclosure.

FIG. 12 illustrates diffuse reflectance infrared Fourier transform (DRIFTS) spectra of solid-state Cu-COF-301@PDMS, a porous liquid made from Cu-COF-301@PDMS suspended in liquid PDMS (10 wt. % COF), and neat PDMS after exposure to 10% CO in He at room temperature, followed by a pure He purge, according to some embodiments of the present disclosure. The stretch observed at 2093 cm 1 is associated with CO bound to Cu(I) sites, redshifted from unbound CO near 2143 cm 1.

FIG. 13 illustrates DRIFTS spectra of Cu(I)-COF@PDMS solid state while heating at 10° C./min under a 100 sccm He flow to remove CO from the Cu(I) site, according to some embodiments of the present disclosure. Note that the background used for each spectra was collected at room temperature, causing some background drift with heating.

FIG. 14 illustrates DRIFTS spectra of a porous liquid made from Cu(I)—COF@PDMS suspended in PDMS while heating at 10° C./min under a 100 sccm He flow to remove CO from the Cu(I) sites, according to some embodiments of the present disclosure. Note that the background used for each spectra was collected at room temperature, causing some background drift with heating.

FIG. 15 illustrates temperature programmed desorption (TPD) measurements show H₂ desorption from uncoated COF-301, COF-301@x ‘thick’ PDMS-MA dosed at room temperature and 77K, and COF-301@x ‘thin’ PDMS-MA dosed at room temperature and 77K, according to some embodiments of the present disclosure. All signals were normalized to the total mass of the sample and the temperature was ramped at 15° C./min.

FIG. 16 illustrates H₂ TPD on uncoated COF-301, crosslinked COF-301@xPDMS-MA dosed with H₂ at room temperature and 77K, and non-crosslinked COF-301@PDMS-MA dosed with H₂ at room temperature and 77K, according to some embodiments of the present disclosure.

FIG. 17 illustrates H₂ TPD on neat PDMS as well as porous liquids made by suspending 11 wt. % and 17 wt. % Cu(I)-COF@PDMS-MA in liquid PDMS, according to some embodiments of the present disclosure. All traces were normalized to the total sample mass.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Among other things, the present disclosure relates to a method for controlling and tuning the temperature at which a gas is released or captured from a framework-based material, e.g., a metal-organic framework (MOF) and/or a covalent organic framework (COF). In short, a polymer membrane is grown around a framework-based particle and the glass transition (T_{g}) temperature of that polymer membrane is used to influence the mass-transport of gases into and/or out of the framework. When the polymer chosen has the correct physiochemical properties and the temperature is above the polymer T_{g}, gas molecules readily diffuse through the rubbery polymer membrane. Below the polymer T_{g}, the polymer membrane becomes glassy and can be used to either trap gas inside the pores or exclude gas from entering. The polymer coating may also change the shape of the sorption isotherms, such that the quantity of “usable” gas may be increased multi-fold.

More specifically, as described herein, a surface-initiated atom transfer radical polymerization (SI-ATRP) procedure may be applied to covalently link a cross-linked membrane around the surface of 3D imine-linked COF colloids. In some embodiments of the present disclosure, a poly(dimethylsiloxane)-methacrylate (PDMS-MA) polymer was used to coat COF colloids that was sufficiently robust to survive temperatures up to and exceeding 200° C. This prevented the aggregation of COF colloids and allowed the activation of the first known Cu(I)-COF-based porous liquids (PLs) for ambient temperature H₂ storage and transport. As used herein, a porous liquid refers to a COF that is immersed in a liquid, for example a liquid polymer. CO and H₂ sorption in these materials were studied using diffuse reflectance infrared Fourier transform (DRIFTS) spectroscopy and temperature programmed desorption (TPD). Further, it is shown herein how the glass transition temperature of the polymer coating and a COF/polymer composition immersed in a second polymer can be employed to influence the kinetics of H₂ diffusion through these nano encapsulated materials. Although the specific examples described herein focus on COFs, other frameworks such as metal organic frameworks (MOFs) may be treated in a similar fashion to generate MOF-based compositions capable of the reversible storage and release of H₂.

Thus, the present disclosure relates generally to compositions based on organic framework materials (OFMs), of which COFs and MOFs are subsets, where the compositions are capable of reversibly adsorbing and desorbing H₂. As shown herein, the mass transport for reversible adsorbing and desorbing can be influenced by a polymer that is covalently bonded to an outer surface of the OFM, by transitioning the polymer from a first state to a second state. When in the first state, the polymer is in a substantially glassy state, whereas when in the second state, the polymer is in a substantially liquid and/or rubbery state. The composition may be reversibly switched between the first state and the second state by changing the temperature of the composition, specifically by changing the composition's temperature from being above its glass transition temperature (T_{g}) to being below its T_{g}. When the composition is at a temperature greater than or equal to the T_{g}, the composition is in the liquid state and/or rubbery state and is capable of reversibly adsorbing and/or desorbing H₂. Once H₂ has been absorbed, the temperature may be dropped below the T_{g}, switching the polymer from the liquid state to the glassy state, essentially trapping the adsorbed H₂ within the internal volume and/or surface area of the OFM. Subsequently, when there is a demand for H₂, the H₂ may be released by simply raising the temperature of the composition above the T_{g}.

In some embodiments of the present disclosure, the T_{g} of the polymer covalently bonded to an outer surface of an OFM may be between −130° C. and +180° C., or between −80° C. and +50° C., where the T_{g} of the polymer is determined with the polymer bonded to the OFM (e.g., not as a neat, pure, unbonded polymer). As described herein, examples of OFMs that may be bonded to a polymer, with the resultant composition capable of reversibly adsorbing and desorbing H₂ include covalent organic frameworks (COFs) and/or metal organic frameworks (MOFs).

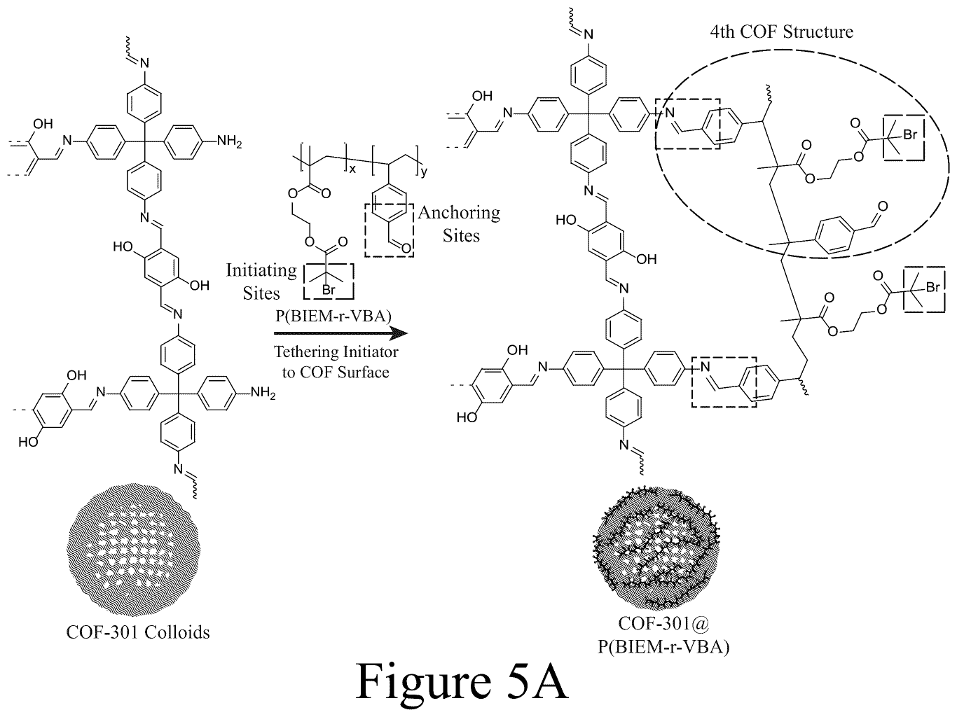

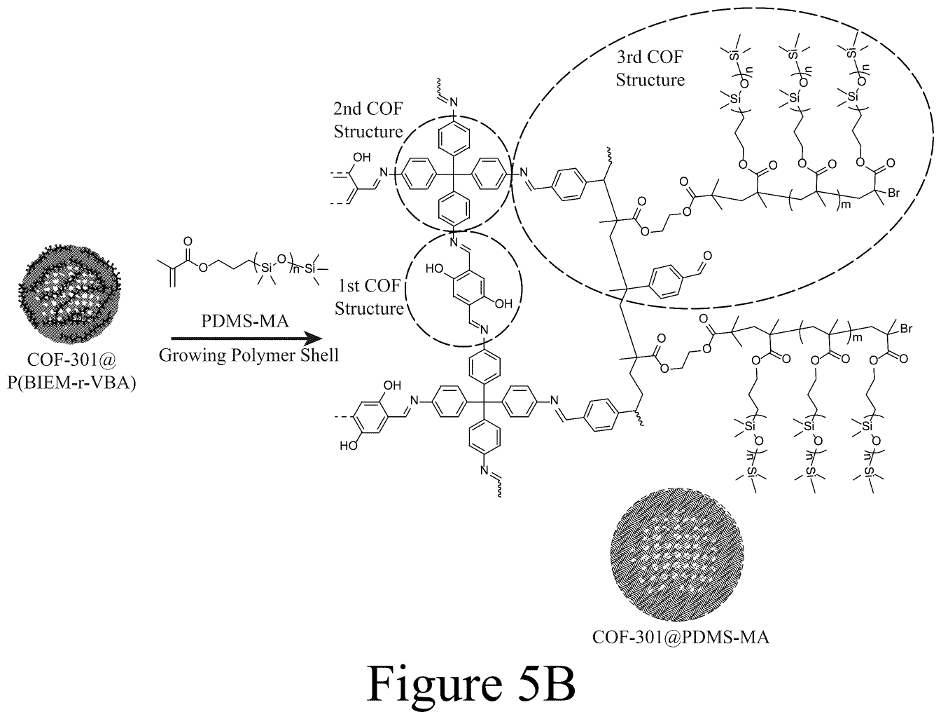

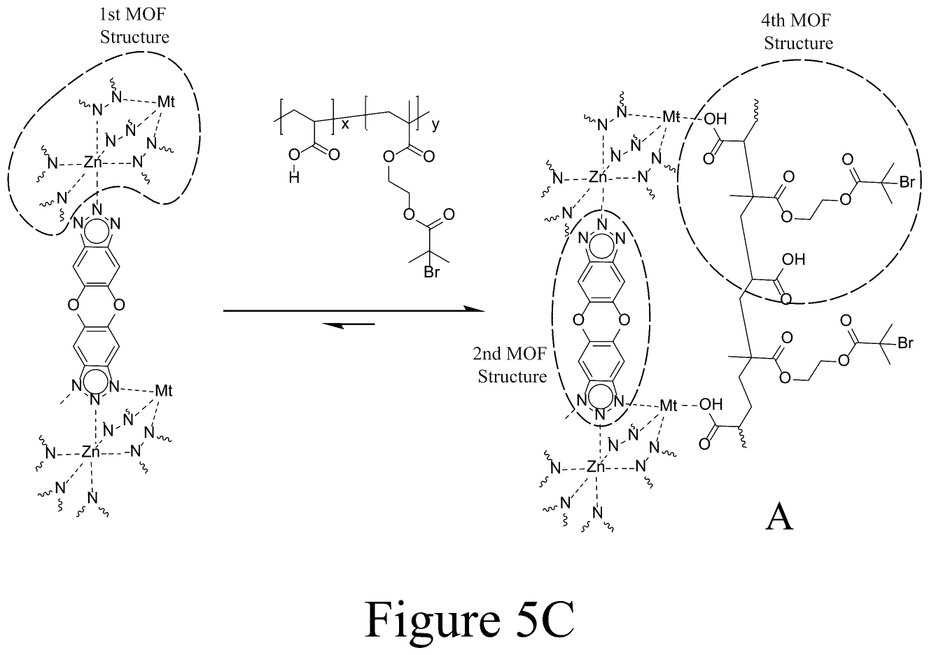

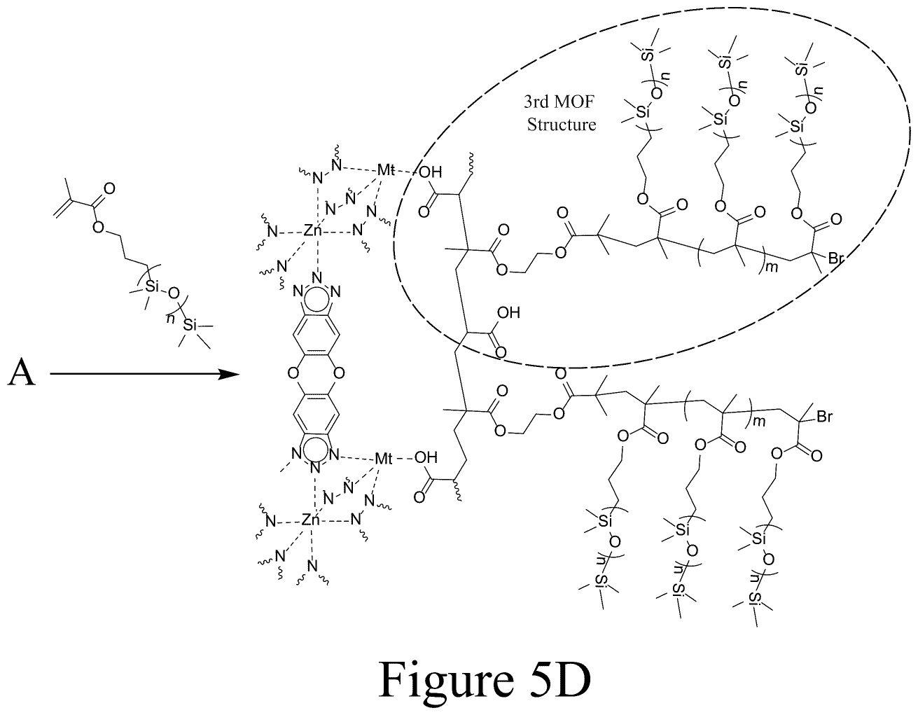

FIGS. 5A and 5B illustrate a synthetic route for manufacturing a coated COF, according to some embodiments of the present disclosure, constructed using three base structures. For the case where COFs are used as a structure for reversibly adsorbing/desorbing H₂, a COF may include a first-row transition metal (Mt), with examples including at least one of Sc, Ti, V, Cr, Mn, Fe, Co, Ni, Cu, and/or Zn. In some embodiments of the present disclosure, the first-row transition metal (Mt) may be chelated with an organic site contained within the COF. This combination of a first-row transition metal (Mt) and an organic site is referred to herein as a First COF Structure, with examples of a First COF Structure including

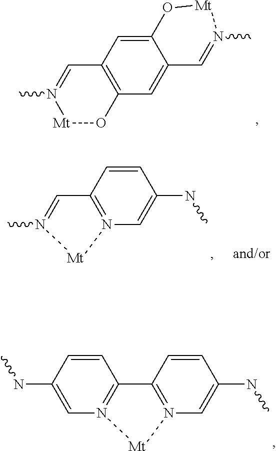

where [symbol] represents a covalent bond to other structures of the COF, as described in more detail below. In some embodiments of the present disclosure, a first-row transition metal (Mt) may be Cu. In some embodiments of the present disclosure, at least a portion of the Cu of a First COF Structure may be in the Cu(I) valence state.

In some embodiments of the present disclosure, a COF may further include a Second COF Structure, where the Second COF Structure is either directly and/or indirectly bonded to the First COF Structure. Examples of Second COF Structures, which when combined with a First COF Structure, result in compositions capable of reversibly adsorbing and desorbing H₂, include

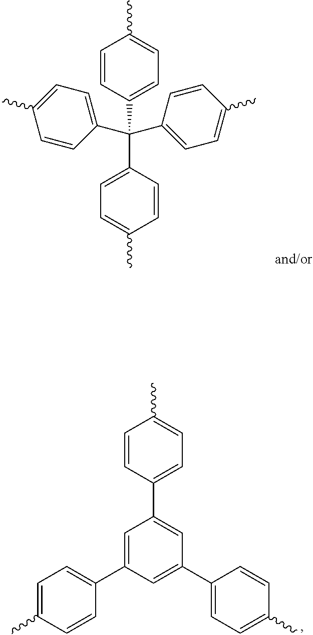

where [symbol] represents a covalent bond to other structures of the COF (e.g., the First COF Structure).

In some embodiments of the present disclosure, the polymer bonded to an outer surface of a COF may include at least one of an acrylate, methacrylate, and/or styrene. In some embodiments of the present disclosure, at least one of an acrylate and/or a methacrylate may include an alkyl chain between 1 and 20, or between 4 and 8 carbon atoms. Thus, in some embodiments of the present disclosure, a polymer bonded to an outer surface of a COF may include at least one of a poly(alkyl acrylate) and/or a poly(alkyl methacrylate). In some embodiments of the present disclosure, at least one of an acrylate and/or a methacrylate bonded to an outer surface of a COF may further include at least one of a siloxane and/or an ethylene oxide. Thus, in some embodiments of the present disclosure, a polymer bonded to an outer surface of a COF may include at least one of polydimethylsiloxane acrylate, polydimethylsiloxane methacrylate, polyethylene glycol acrylate and/or polyethylene glycol methacrylate.

In some embodiments of the present disclosure, a polymer bonded to the surface of a COF may form a structure, referred to herein as a Third COF Structure, which may include the following,

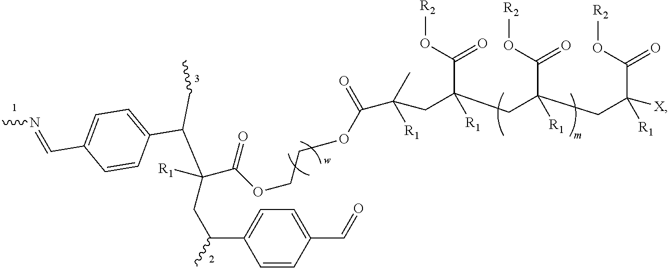

where w may be between 0 and 20, inclusively, or between 1 and 8, inclusively, and m may be between 1 and 500, inclusively, or between 5 and 50, inclusively. Bond 1 represents a bond between a Third COF Structure and a nitrogen atom of a Second COF Structure and bonds 2 and 3 each represent a bond between the Third COF Structure and another Third COF Structure or a Fourth COF Structure, which is defined below. Referring again to the Third COF Structure, in some embodiments of the present disclosure, X may include a halogen, for example at least one of Br, Cl, and/or I. In some embodiments of the present disclosure, R₁ may include at least one of a methyl group and/or a hydrogen atom. In some embodiments of the present disclosure, R₂ may include at least one of an alkyl chain, a siloxane, and/or an ethylene oxide. In some embodiments of the present disclosure, R₂ may be an alkyl chain having between 1 and 20 carbon atoms, inclusively, or between 4 and 8 carbon atoms, inclusively. In some embodiments of the present disclosure, R₂ may include at least one of

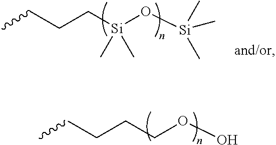

where n is between 1 and 500, inclusively, or between 5 and 50, inclusively.

In some embodiments of the present disclosure, a composition that includes a COF may include another structure, referred to herein as a the Fourth COF Structure, where the Fourth COF Structure may be defined by

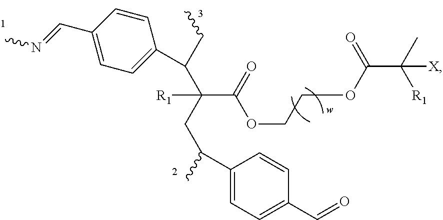

where w, X, and R₁ are as defined above for the Third COF Structure. Bond 1 represents a bond between a Fourth COF Structure and a nitrogen atom of a Second COF Structure and bonds 2 and 3 each represent a bond between the Fourth COF Structure and another Fourth COF Structure or a Third COF Structure, which is defined above.

In some embodiments of the present disclosure, a composition for adsorbing/desorbing H₂ as described above may be further characterized by a number of physical properties and/or performance metrics. For example, in some embodiments of the present disclosure, a COF-containing composition may have an average pore size between about 1 Å and about 40 Å, inclusively, or between about 4 Å and about 25 Å, inclusively. In some embodiments of the present disclosure, a COF-containing composition may have an average surface area greater than or equal to about 400 m²/g, or between about 50 m²/g and about 3000 m²/g, inclusively. In some embodiments of the present disclosure, a COF-containing composition may form a substantially spherically shaped particle having an average diameter between about 10 nm and about 10 μm, or between about 50 and about 400 nm. In some embodiments of the present disclosure, a COF-containing composition, with the polymer covalently bonded to a surface of the COF, may have an H₂ loading greater than or equal to about 0.01 g H₂/g, or between about 0.001 g H₂/g and about 0.04 g H₂/g.

In some embodiments of the present disclosure, a composition as described above may further include a second polymer, such that a COF with a first polymer bonded to at least a portion of its outer surface is immersed in the second polymer. Examples of polymers that may be utilized as a “second polymer” include at least one of polydimethylsiloxane, polyethyleneimine, polyethylene glycol, poly(alkyl acrylate), and/or poly(alkyl methacrylate). A “second polymer”, like the “first polymer” described above that is covalently bonded to a surface of the COF may also be characterized by a T_{g}, as measured when the second polymer is neat (i.e., pure and not bonded to a substrate). In some embodiments of the present disclosure, the T_{g} of a second polymer may be between about −130° C. and about +180° C., or between about −80° C. and about +50° C. In some embodiments of the present disclosure, a second polymer may be a semi-crystalline polymer with a melting point between about −40° C. and about +180° C., or between about 0° C. and about +50° C. The presence of a second polymer provides additional tunability over the desorption temperature of H₂. The second polymer may more efficiently trap H₂ in the COF composition than a composition lacking the second polymer. Adjusting the ratio of the second polymer and the COF in the composition provides a means for optimizing the composition to store H₂ for a given duration of time, which may be between 1 and 7 days, between 7 days and 365 days, or between 1 and 3 years. In some embodiments of the present disclosure, the T_{g} of a first polymer may be approximately equal to the T_{g} of a second polymer. In some embodiments of the present disclosure, the T_{g} of a first polymer may be different than the T_{g} of a second polymer.

In some embodiments of the present disclosure, an OFM may be a metal organic framework (MOF) that includes a first row transition metal (Mt), with examples including at least one of Sc, Ti, V, Cr, Mn, Fe, Co, Ni, Cu, and/or Zn. In some embodiments of the present disclosure, the first-row transition metal (Mt) may be chelated with an organic site contained within the MOF. FIGS. 5C and 5D illustrate a synthetic route for manufacturing a coated MOF, according to some embodiments of the present disclosure, constructed using three base structures. A combination of a first-row transition metal (Mt) and an organic site is referred to herein as a First MOF Structure, with examples of a First MOF Structure including

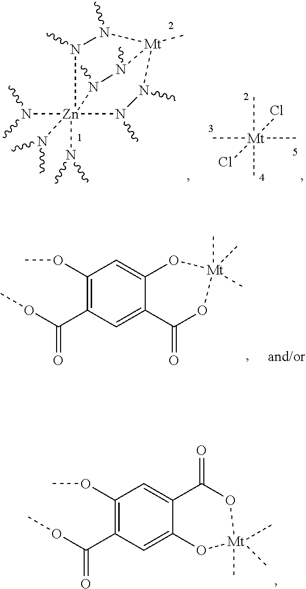

where [symbol] represents a covalent bond to other structures of the MOF, as described in more detail below, and [symbol] represents coordinate or ionic bonds of at least one of a Mt—O bond, a Mt—N bond, and/or a Mt-halogen bond. In some embodiments of the present disclosure, a first-row transition metal (Mt) may include at least one of Ni and/or Co. In some embodiments of the present disclosure, a first-row transition metal (Mt) may include at least one of Ni(II) and/or Co(II). Bonds 1, 3, 4, and 5 represent coordinate bonds between the First MOF Structure and a Second MOF Structure, as described below. Bond 2 represents a coordinate bond to a Third MOF Structure or a Fourth MOF Structure, as described below. In the first example of the First MOF Structure, all Nitrogen atoms belong to the Second MOF Structure but are included here for clarity. In the third and fourth examples of the First MOF Structure, the First MOF Structure is the repeat unit; there is no Second MOF Structure.

In some embodiments of the present disclosure, a MOF may further include a Second MOF Structure, where the Second MOF Structure is either directly and/or indirectly bonded to the First MOF Structure. Examples of second structures, which when combined with a First MOF Structure result in compositions capable of reversibly adsorbing and desorbing H₂, include

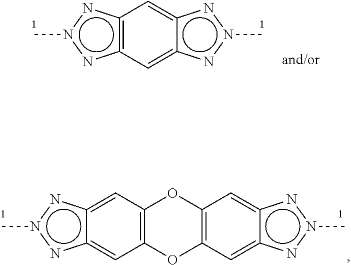

where bond 1 represents a coordinate Mt—N bond to a First MOF Structure.

In some embodiments of the present disclosure, the polymer bonded to an outer surface of a MOF may include at least one of an acrylate, methacrylate, siloxane, an ethylene oxide, or styrene. In some embodiments of the present disclosure, at least one of an acrylate and/or a methacrylate may include an alkyl chain between 1 and 20, or between 4 and 8 carbon atoms. Thus, in some embodiments of the present disclosure, a polymer bonded to an outer surface of a MOF may include at least one of a poly(alkyl acrylate) and/or a poly(alkyl methacrylate). In some embodiments of the present disclosure, at least one of an acrylate and/or a methacrylate bonded to an outer surface of a MOF may further include at least one of a siloxane and/or an ethylene oxide. Thus, in some embodiments of the present disclosure, a polymer bonded to an outer surface of a MOF may include at least one of polydimethylsiloxane acrylate, polydimethylsiloxane methacrylate, polyethylene glycol acrylate and/or polyethylene glycol methacrylate.

In some embodiments of the present disclosure, a polymer bonded to the surface of a MOF may form a structure, referred to herein as a Third MOF Structure, which may include the following,

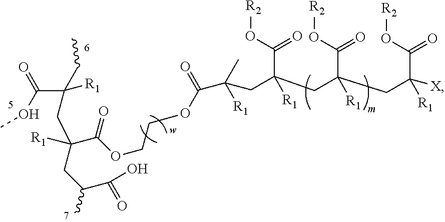

where w may be between 0 and 20, inclusively, or between 1 and 8, inclusively, and m may be between 1 and 500, inclusively, or between 5 and 50, inclusively. Bond 5 represents a coordinate bond between the Third MOF Structure and a nitrogen atom of the Second MOF Structure and bonds 6 and 7 each represent a bond between the Third MOF Structure and another Third MOF Structure or a Fourth MOF Structure, which is defined below. Referring again to the Third MOF Structure, in some embodiments of the present disclosure, X may include a halogen, for example at least one of Br, Cl, and/or I. In some embodiments of the present disclosure, R₁ may include at least one of a methyl group and/or a hydrogen atom. In some embodiments of the present disclosure, R₂ may include at least one of an alkyl chain, a siloxane, and/or an ethylene oxide. In some embodiments of the present disclosure, an alkyl chain in R₂ may have between 1 and 20 carbon atoms, inclusively, or between 4 and 8 carbon atoms, inclusively. In some embodiments of the present disclosure, R₂ may include at least one of

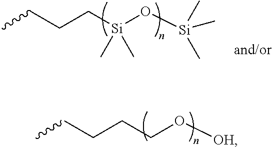

where n is between 1 and 500, inclusively, or between 5 and 50, inclusively.

In some embodiments of the present disclosure, a composition that includes a MOF may include another structure, referred to herein as a the Fourth MOF Structure, where the Fourth MOF Structure may be defined by

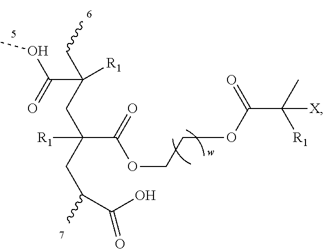

where w, X, and R₁ are as defined above for the Third MOF Structure. Bond 5 represents a coordinate bond between the Fourth MOF Structure and a nitrogen atom of the Second MOF Structure and bonds 6 and 7 each represent a bond between the Fourth MOF Structure and another Fourth MOF Structure or a Third MOF Structure, as described above.

In some embodiments of the present disclosure, a composition for adsorbing/desorbing H₂ may be further characterized by a number of physical properties and/or performance metrics. For example, in some embodiments of the present disclosure, a MOF-containing composition may have an average pore size between about 1 Å and about 40 Å, inclusively, or between about 4 Å and about 25 Å, inclusively. In some embodiments of the present disclosure, a MOF-containing composition may have an average surface area greater than or equal to about 400 m²/g, or between about 50 m²/g and about 3000 m²/g, inclusively. In some embodiments of the present disclosure, a MOF-containing composition may form a particle having an average diameter between about 10 nm and about 10 μm, or between about 50 and about 400 nm. In some embodiments of the present disclosure, a MOF-containing composition, with the polymer covalently bonded to a surface of the MOF, may have an H₂ loading greater than or equal to about 0.01 g H₂/g, or between about 0.001 g H₂/g and about 0.08 g H₂/g.

In some embodiments of the present disclosure, a composition as described above may further include a second polymer, such that the MOF composition with a first polymer bonded to at least a portion of its outer surface is immersed in the second polymer. Examples of polymers that may be utilized as a “second polymer” include at least one of polydimethylsiloxane, polyethyleneimine, polyethylene glycol, poly(alkyl acrylate), and/or poly(alkyl methacrylate). A “second polymer”, like the “first polymer” described above that is covalently bonded to a surface of the MOF may also be characterized by a T_{g}, as measured when the second polymer is neat (i.e., pure and not bonded to a substrate). In some embodiments of the present disclosure, the T_{g} of a second polymer may be between about −130° C. and about +180° C., or between about −80° C. and about +50° C. In some embodiments of the present disclosure, the T_{g} of a first polymer may be approximately equal to the T_{g} of a second polymer. In some embodiments of the present disclosure, the T_{g} of a first polymer may be different than the T_{g} of a second polymer.

The present disclosure relates to the OFM compositions described above, as well as methods for making OFM compositions. In general, a method for making an OFM composition capable of reversibly storing H₂ starts with the selection and/or synthesis of a suitable OFM (e.g., at least one of a COF and/or a MOF), which itself, even without the addition of a polymer to its surface, may be capable of reversibly adsorbing H₂ and desorbing H₂. Examples of OFMs include COFs and MOFs, of which each family is described above in detail. Next, a method of making an OFM-containing composition may include a step for bonding a polymer to an outer surface of the OFM. This polymer is referred to above as a “first polymer”. This addition of a first polymer to a surface of an OFM may involve multiple steps, depending upon the functional groups present on the surface of the OFM, as well as the structure and functional groups provided by the first polymer. A first polymer, once bonded to the OFM, should be capable of switching between a first glassy state and a second “softer” state upon transition through a temperature and/or temperature range. In some embodiments of the present disclosure, a method may continue by immersing the OFM composite material, with a first polymer bonded to at least a portion of its surface, in a second polymer. A second polymer may be characterized by being capable of reversibly switching between a first glassy state and a second “softer” state upon transition through a temperature and/or temperature range. This combination of an OFM, a first polymer, and a second polymer, as shown herein, can result in a final composition having a high adsorption capacity for H₂, which can be released when needed. Among other things, a first polymer may act as a barrier to a second polymer, preventing the second polymer from infiltrating into the inner volume and/or surface area of OFM, leaving it available for H₂ adsorption, whereas the second polymer may act as the primary barrier to H₂ mass transfer in and out of the OFM, depending on its state, glassy or more liquid-like. These concepts are described in more detail in the following sections.

An exemplary method for synthesizing polymer/OFM compositions utilized a general surface-initiated atom transfer radical polymerization (SI-ATRP) procedure that chemically bonded a poly(dimethylsiloxane)-methacrylate (PDMS-MA) polymer (a “first polymer”) to the surface of 3D imine-linked COF colloids. A PDMS-MA polymer was chosen because, among other things, it can withstand temperatures up to about 200° C., thereby preventing aggregation of COF colloids and allowing the activation of copper to Cu(I), thereby enabling the synthesis of a Cu(I)-COF composition capable of ambient temperature H₂ storage and transport. As shown herein, the CO and H₂ sorption characteristics of these compositions were studied using diffuse reflectance infrared Fourier transform (DRIFTS) spectroscopy and temperature programmed desorption (TPD). These studies demonstrate how the glass transition temperature of the first polymer bonded to the COF, as well as a second polymer into which the COF/polymer composition can be immersed, affected the kinetics of H₂ diffusion through these nano-encapsulated materials.

With the goal of synthesizing stable COF colloids containing Cu(I) contained in a First COF Structure of the COF such that the COF is capable of ambient temperature gas storage (e.g., H₂) and transport in porous liquids (i.e., COFs immersed in a liquid), COF-301 was selected. Atomic Cu(I) can be positioned in phenol-imine docking sites (of a First COF Structure) of this particular 3D imine-based COF with a post-synthetic modification and activation procedure, after which stable complexes with H₂, C₂H₄, and CO could be formed and detected near ambient temperature in bulk COF powder as described in J. Phys. Chem. C 2022, 126 (35), 14801-14812, which is incorporated herein by reference in its entirety. In addition, the particle size of the resultant COFs could be tuned using dilute nitrile-based solvents and optimized catalysts as described in J. Mat. Chem. A 2020, 8, 23455 23462, hereinafter referred to as the Mow reference, which is incorporated herein by reference in its entirety. This second method was used to synthesize the first reported colloids of COF-301.

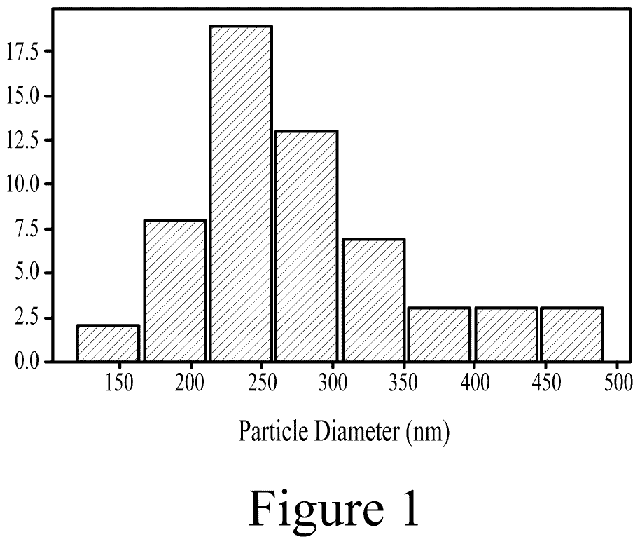

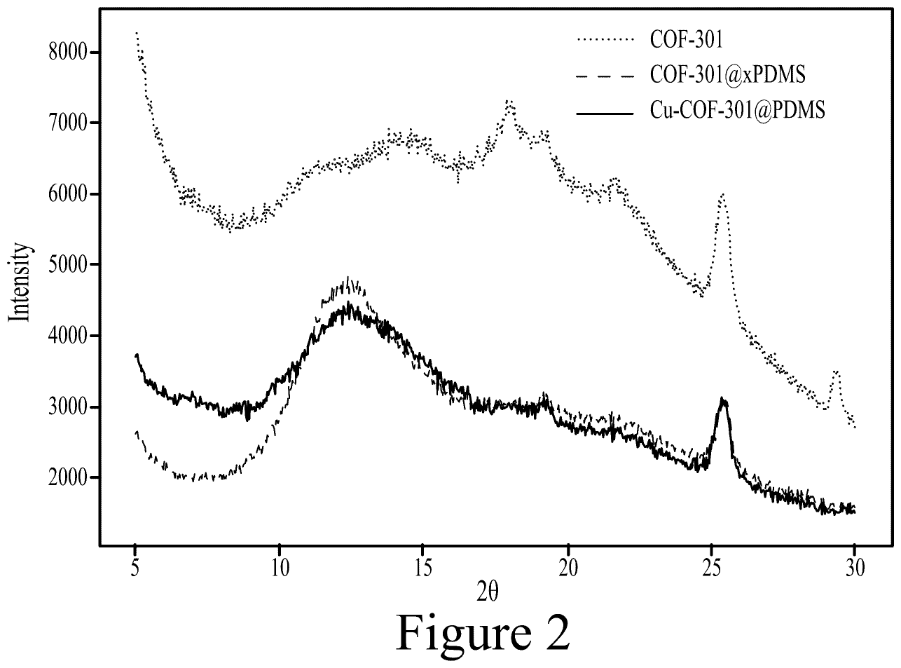

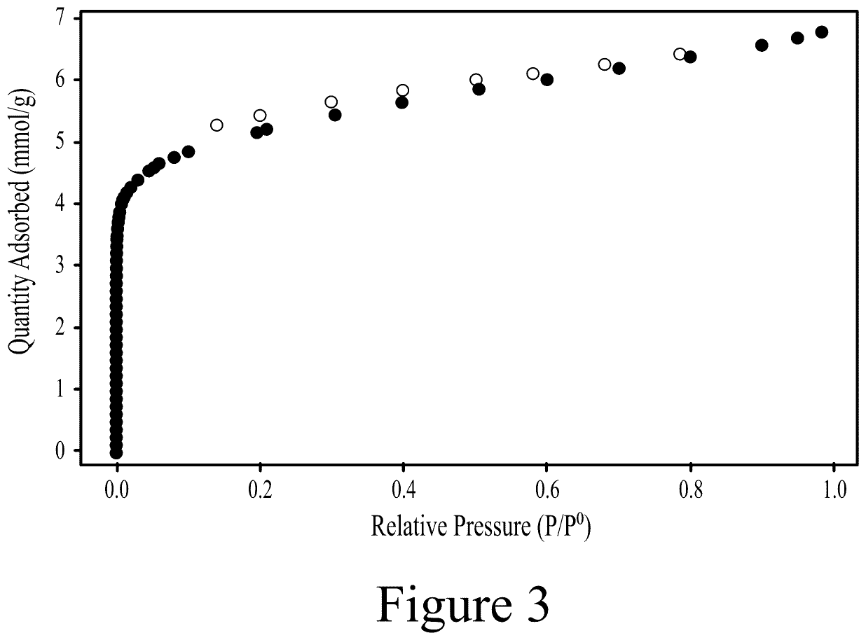

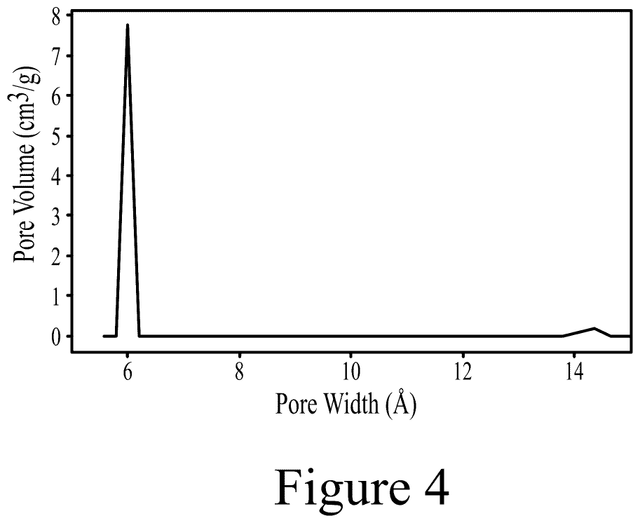

Under the conditions outlined in the experimental section below, COF-301 formed spherical particles with a median diameter of 260 nm but having a diameter between 160 nm and 460 nm, as determined by TEM imaging and dynamic light scattering (see FIG. 1). Powder x-ray diffraction (PXRD) measurements suggest this COF was semi-crystalline, though like previous 3D colloidal COF analogues, the features in the PXRD spectrum are quite broad and difficult to interpret (see FIG. 2). The BET surface area was approximated as 400 m²/g from the N₂ isotherm (see FIG. 3), and the pore size distribution of the COF-301 colloids revealed a strong monodisperse peak near 6 Å (see FIG. 4). Optimization of COF surface areas and crystallinity is typically achieved by modifying numerous synthetic conditions, e.g., the polarity of the solvent, the reagent and catalyst concentration, the moisture content, reaction time and temperature, etc. However, given that these COFs only remain colloidal in nitrile-based solvents for about 72 hours in the presence of a catalyst, optimization focused on tuning concentration and temperature.

After their synthesis, the colloids were purified by removing unreacted monomer and acid catalyst through centrifugation, decanting the supernatant, and immediate resuspension in fresh acetonitrile. As long as the COF-301 colloids remained in acetonitrile, they could stay suspended indefinitely (>1 year). However, if dried or placed in a different (co)solvent suspension, irreversible aggregation occurred rapidly, presumably due to the reaction of interparticle surface amines and aldehydes. The standard procedure for post synthetic loading of COF-301 with metal salts (e.g., stirring the COF in a Cu(II) formate solution) also induced near instant and irreversible aggregation of the colloids, presenting a challenge on how to add Cu binding sites in these materials while keeping them colloidal.

A surface functionalization technique for stabilizing COF colloids (see the Mow reference) was used that involved tethering a bulky imidazolium salt to unreacted amines on the colloid surface. The strategy proved effective at stabilizing COF colloids in a variety of organic solvents and ionic liquids and was successfully applied here to the COF-301 colloids, which were successfully loaded with Cu(II) formate, after which the suspension remained colloidal. The colloids turned from yellow-orange to red-brown upon loading with Cu. The surface functionalized colloids could now be thoroughly dried under vacuum and resuspended in common organic solvents. However, upon “activating” the COF and converting the Cu(II) formate to open Cu(I) sites in these materials by heating for several hours at 180° C., the colloids once again aggregated irreversibly. Although stable at 100° C., it appears the bonded imidazolium salt is not sufficiently robust at temperatures required to generate open Cu(I) sites with this technique. The imidazolium salt with an aldehyde functionality in it, was bonded to the surface of the COF in much the same way the polymer in the Third COF Structure was bonded to the COF. This resulted in the COF being miscible with ionic liquids where it otherwise wasn't. However, because it had only one anchoring point, whereas the polymer has many anchoring points, the latter appears stable to higher temperatures.

Due to these temperature instabilities, efforts then focused on implementing a more robust surface functionalization strategy for modifying the surface of a COF to enable the successful synthesis of Cu(I) loaded COF colloids suitable for porous liquid applications, for example reversible gas adsorption.

Using radical addition-fragmentation chain-transfer (RAFT) polymerization, a copolymer of 2-(2-bromoisobutyryloxy)ethyl methacrylate (BIEM) and 4-vinyl benzaldehyde (VBA) was synthesized. The aldehyde groups in this random copolymer P(BIEM-r-VBA) (see FIGS. 5A and 5B) could then be reacted with surface amines on the COF-301 colloids, effectively acting as a multi-dentate binding agent that formed a thin polymeric coating on the surface of the colloids, a precursor to the Third COF Structure illustrated above. Once this thin coating was in place, the colloids were now stable in solvents other than acetonitrile. This allowed the colloids to be suspended in a variety of additional solvents and monomers, from which thicker, more robust polymer coatings (i.e., first polymer) could be grown via atom transfer radical polymerization using the Br-sites in the P(BIEM-r-VBA) coating (see the Fourth COF Structure illustrated above). In summary, with the polymeric coatings in place, it was discovered how to load the colloids with Cu, activate the materials at 200° C. to generate open Cu(I) sites, and resuspend the activated colloids to generate Cu(I) based porous liquids (i.e., compositions). These experiments are described in more detail below, describing the conditions for (1) growing polymeric coatings based on polydimethylsiloxane-methacrylate (PDMS-MA) of controlled thicknesses around COF colloids; (2) loading these coated colloids with Cu and characterizing the activated materials; and (3) studying and characterizing the characteristics of these composite materials, once immersed in a liquid (e.g., PDMS), for storage applications of H₂ and/or CO.

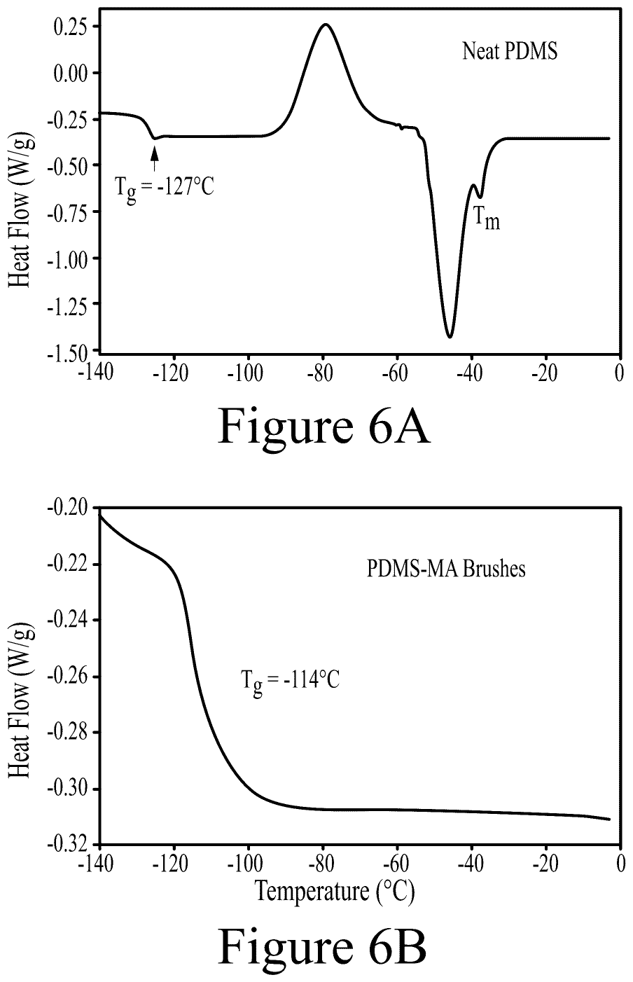

Controlling polymer membrane thickness: Essentially any vinyl monomer compatible with ATRP could be employed for the polymeric membrane, e.g., the “first polymer” as described above, for a COF-containing composition. PDMS-MA was chosen as the first polymer and PDMS as the second polymer into which the polymer/COF composition may be immersed, for a variety of reasons. PDMS is inexpensive and relatively non-toxic. The low vapor pressure and high thermal stability of this polymer ensures that the PDMS-MA-coated COFs can be activated at high temperatures without incurring decomposition of the coating. The fluidity of PDMS down to −40° C. also makes the solvent promising for low viscosity porous liquids applications (see FIGS. 6A and 6B).

Synthesis of consistent, uniform PDMS-MA polymer coatings on the surfaces of colloids requires evaluation of the polymerization conditions. While linear PDMS cannot be grown via living polymerization techniques, so-called ‘bottlebrush’ PDMS-MA polymers can be grown via ATRP and are a good analogue with similar properties to PDMS. However, due to the nature of these materials (e.g., the densely grafted side chains), bottlebrush polymers can be challenging to synthesize in a controlled manner. As described herein, conditions were discovered that allowed the controlled synthesis of bottlebrush PDMS-MA that are simultaneously compatible with keeping COF-301 colloids well-dispersed.

An interesting feature of these materials is their tendency to depolymerize under certain conditions, which is caused by significant bond strain due to the bulkiness of these materials. Significant work has been implemented to understand the equilibrium between polymerization and depolymerization in the radical polymerization of these brush materials. Solvent selection, reaction temperature, and initial monomer concentration can all influence this equilibrium, yields, and molecular weights. High monomer concentrations drive polymerization, while good solvation of the polymer along with subsequent brush swelling and bond strain drive depolymerization. At some point during a reaction, the monomer concentration drops low enough to where polymerization and depolymerization are effectively in equilibrium, and chain growth halts.

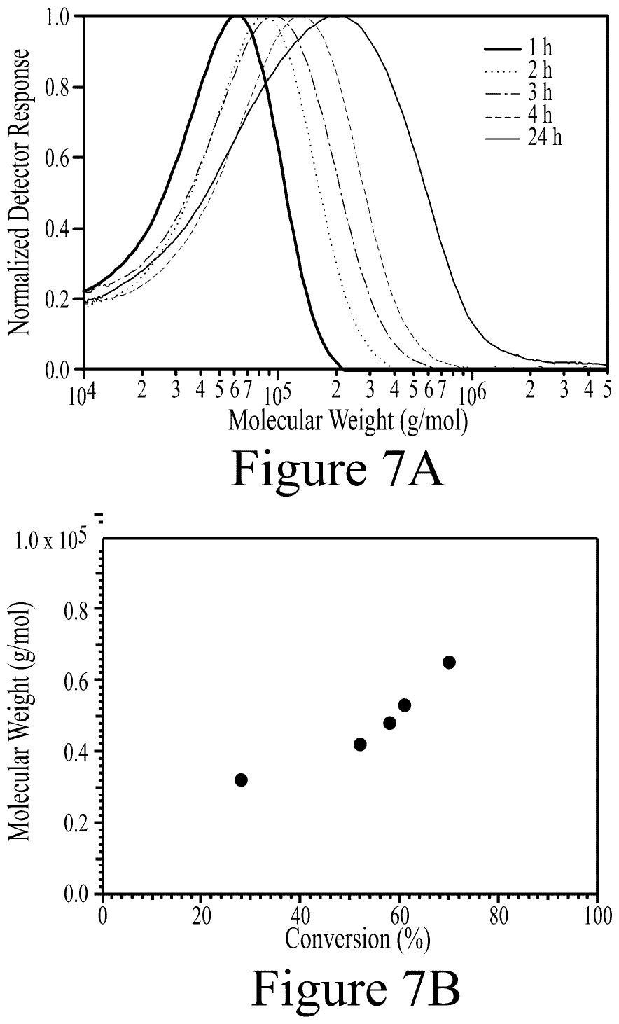

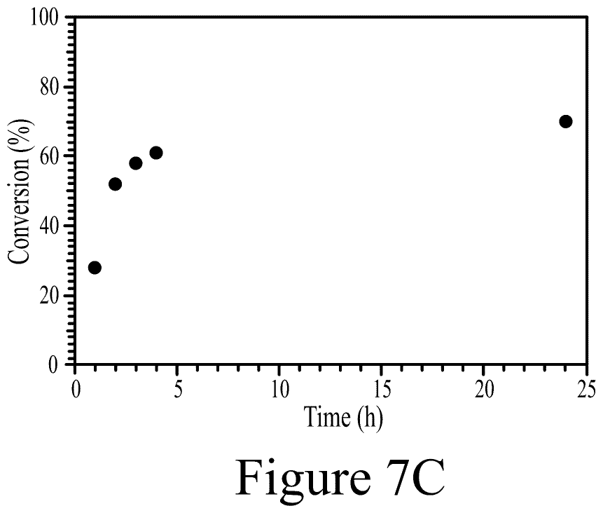

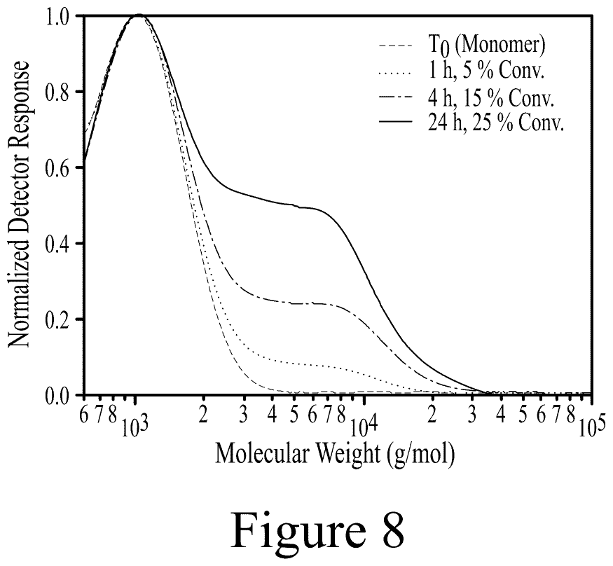

A model ATRP reaction of PDMS-MA was conducted in acetonitrile, as this solvent may be optimal for keeping colloids dispersed when later conducting surface-initiated ATRP. However, while the polymerization proceeded, the poor solubility/immiscibility of the PDMS-MA brushes in acetonitrile led to poorly controlled chain growth with large batch to batch variability. In pure dioxane, the brushes were well solvated, but both the ATRP catalyst and the colloids were not, leading again to uncontrolled polymer growth. A 90:10 mixture of dioxane:acetonitrile was discovered to be the best compromise for catalyst solubility, brush solubility, and colloid dispersion. By employing CuCl/Me₆TREN as the catalyst at room temperature, systematic chain growth between 20 and 35 Kg/mol was achieved using monomer:initiator ratios of 200:1 (see FIGS. 7A-7C), with ˜70% conversion reached in 24 hours. By decreasing that ratio to 20:1, molecular weights below 10 Kg/mol were achieved (see FIG. 8).

Cu-loaded COF@xPDMS: With the propensity of COF colloids to flocculate, chemically bonding the colloids with a protective polymeric coating is a promising strategy to facilitate post-synthetic modifications and material activation. Here, the optimized bottlebrush PDMS-MA polymerization was applied to coat COF colloids with robust PDMS-MA coatings that enable Cu-loading and activation without irreversible aggregation. Although optimized for PDMS-MA polymerization, this general strategy can in principle be applied to tether any methacrylate-terminated polymer to the surface of imine-linked COFs.

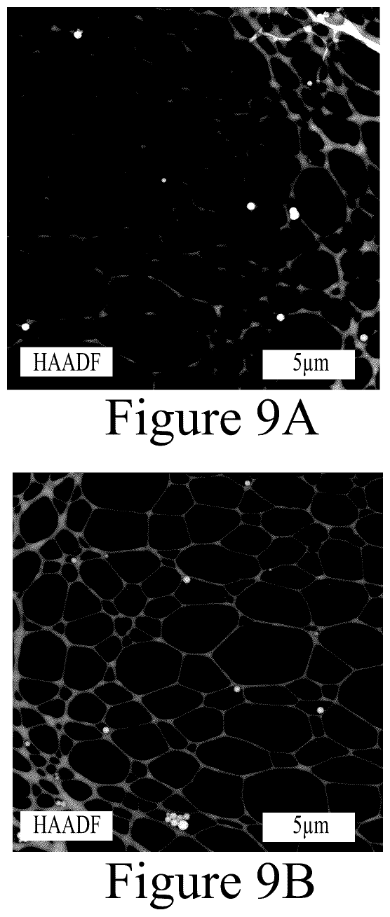

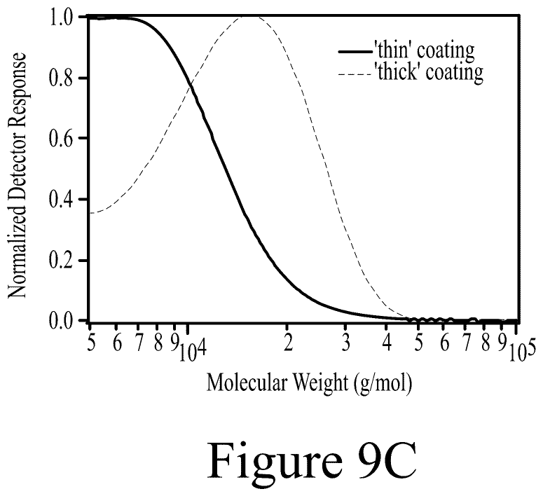

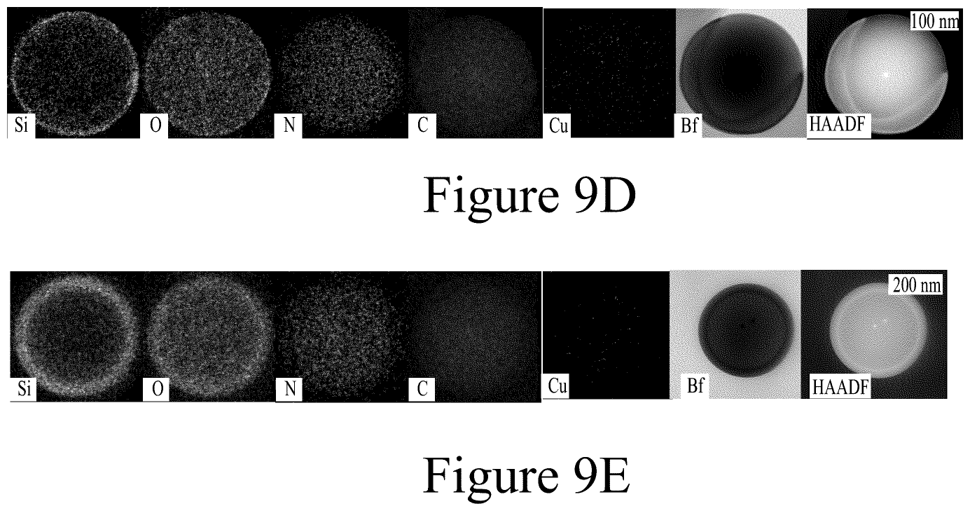

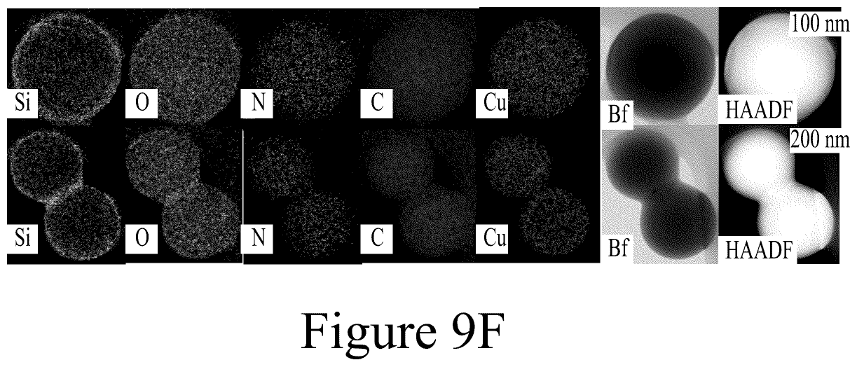

A PDMS-MA coating was grown from the surface of COF-301 colloids using the best procedure described herein. Briefly, the P(BIEM-r-VBA) polymeric initiator (see FIGS. 5A and 5B) was applied to the COF colloids, purified of acid catalyst and excess unreacted polymeric initiator, and then surface-initiated ATRP (SI-ATRP) was conducted to grow uniform PDMS-MA coatings around the COF colloids. High angle annular dark-field (HAADF) imaging, shown in FIG. 9A, illustrates how individual particles of COF-301@PDMS-MA can be deposited from dichloromethane following the coating procedure. Notably, many of the particles remain individually dispersed following loading with Cu(II)formate (vide infra), purification via centrifugation, drying, resuspension in and finally deposition from dichloromethane (see FIG. 9B). Without the protective coating, this cannot be achieved. The distribution of particle sizes, estimated by DLS, following the coating procedure for a representative batch of materials is shown in FIG. 9C.

The uniformity of the coating can be observed with scanning transmission electron microscopy (STEM) images of individual particles. Furthermore, energy-dispersive x-ray spectroscopy (EDS) mapping was employed to clearly distinguish the outer coating from the inner COF core, as Si atoms were uniquely present in the coating and N atoms in the COF (see FIGS. 9E-9G). Trace Cu could also be observed in the coated COF (see FIGS. 9E and 9F), due to residual ATRP Cu catalyst. Variation of the monomer to initiator ratio during the polymerization afforded control over the coating thickness; ‘thin’ coatings (see FIG. 9E, estimated by STEM to be ˜5 nm) were grown using a 20:1 monomer:initiator ratio, while ‘thick’ coatings (see FIG. 9F, ˜30 nm) were achieved with a 200:1 ratio. Untethered ‘sacrificial’ initiator was also injected during these surface-initiated polymerization, as tethered and untethered chains grow at approximately the same rate during living radical polymerizations. Thus, the molecular weights of the sacrificial chains measured using size-exclusion chromatography (see FIG. 9D) by sampling the ‘thin’ and ‘thick’ reactions (Mn ˜5 and 15 Kg/mol, respectively) can be considered a good estimate of the molecular weights of the individual chains tethered to the surface of the COF (see FIGS. 9E and 9F). Elemental analysis suggests the thick PDMS-MA shell constituted 25% of the overall sample mass, with the thin shell being 10% of the overall sample mass.

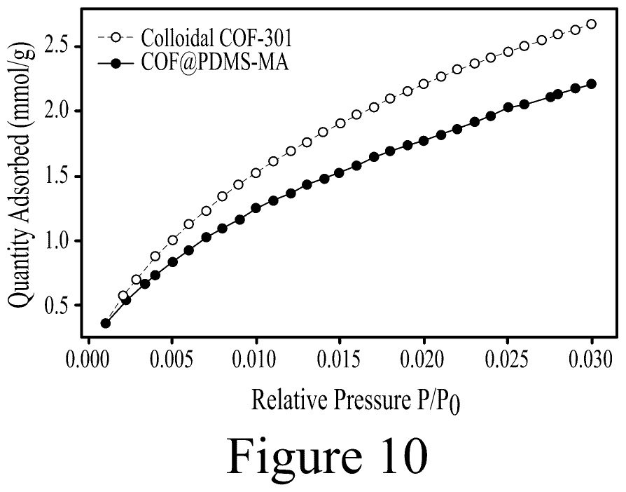

A Brunauer-Emmet-Teller (BET) surface area analysis using an N₂ isotherm was not useful once the coating was applied, as the coating effectively acts as a glassy encapsulant to exclude N₂ adsorption at cryogenic temperatures (vide infra). However, at 0° C., where the coating is rubbery, CO₂ adsorption into COF-301@‘thick’ PDMS-MA was estimated to be 80% of that of the uncoated material. When mass normalized to account for the sample coating, the adsorption of the active COF material remains essentially identical before and after the coating procedure (see FIG. 10).

Compared to uncoated COF colloids that irreversibly aggregate, the COF-301@PDMS-MA particles readily resuspended in PDMS and other solvents after drying at 200° C. under ultra-high vacuum (see FIG. 9B). Once stabilized by the coating, the colloids could also then be loaded with Cu(II)formate to introduce Cu(I) binding sites for H₂ and other gases capable of x-backbonding. Cu has been incorporated at the phenol-imine site in bulk COF-301 by stirring in a Cu(II)formate methanol solution. However, this procedure was found to be inadequate for introducing Cu into the coated COF, possibly due to the poor miscibility of methanol with the PDMS-MA coating. By changing the solvent to 1:1 mixture of dichloromethane and methanol, which visibly swelled the coating, Cu(II) formate appeared to readily permeate the uncrosslinked PDMS-MA coating and was taken up by the COF. Similar materials were made using added crosslinker in the synthesis of the membrane. However, when the membrane was crosslinked, Cu(II)formate uptake took place slowly over about 1 week vs. mere hours when not crosslinked.

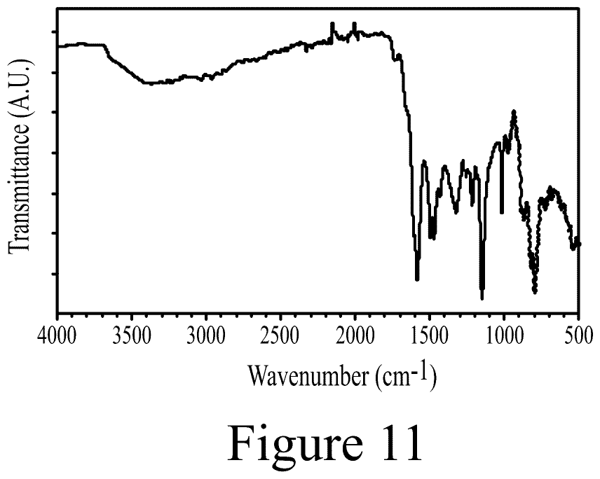

The COF changed color from orange to red-brown upon addition of Cu. Features in the FT-IR spectra shifted upon Cu loading that were consistent with binding at the phenol-imine site (e.g., a shift in the imine stretch from 1610 to 1590 cm⁻¹ was observed; see FIG. 11). ICP analysis was employed to estimate the metal-loaded sample to be 7 wt. % Cu, similar to the 10 wt. % Cu that the uncoated COF-301 will uptake with this procedure.

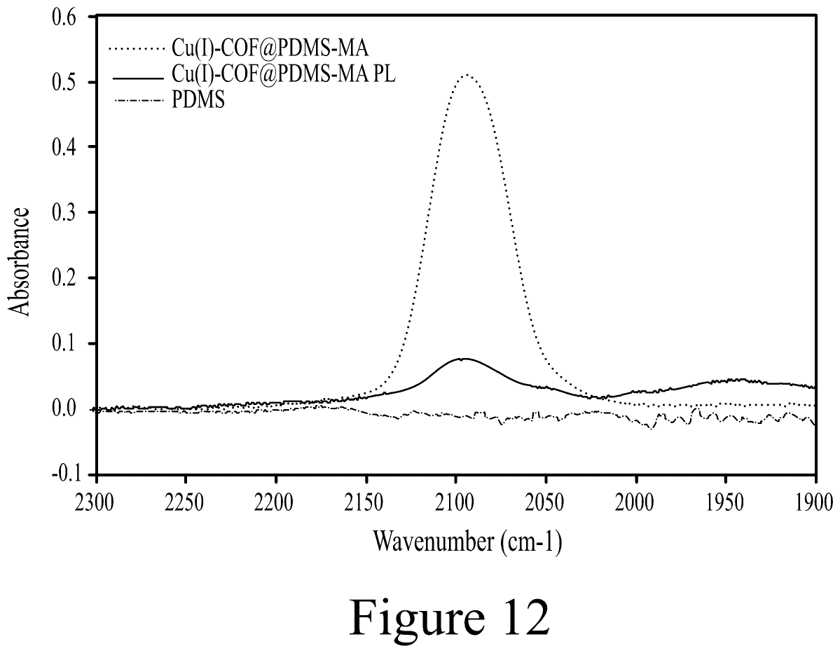

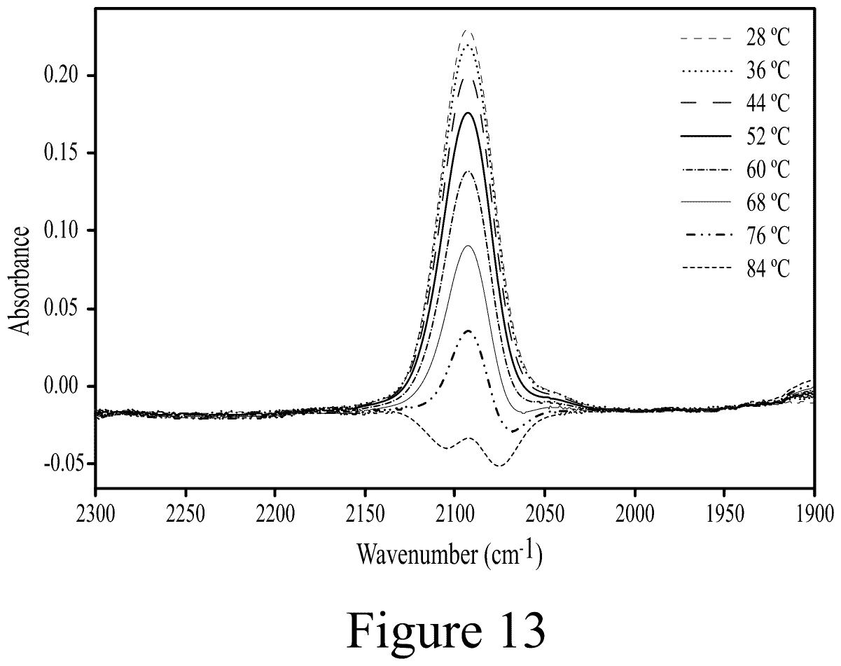

Gas sorption in Cu(I)-based porous liquid: The availability of the Cu(I) site in Cu-COF-301@PDMS-MA was confirmed by dosing the system with carbon monoxide (CO) and studying its response using Diffuse Reflectance Infrared Fourier Transform Spectroscopy (DRIFTS). A stretch associated with the CO—Cu(I) complex was observed at 2093 cm⁻¹ in FIG. 12. This redshift from unbound CO (centered near 2143 cm 1) is consistent with previous reports of CO—Cu(I) complexes and indicates strong x-backbonding interactions. The stretch at 2093 cm 1 appeared immediately after exposure to 10% CO in He, and the CO remained bound to the Cu(I) site when the sample was purged at room temperature with He. The sample was then heated at 10° C./min to begin desorbing CO. The CO—Cu(I) stretch fully disappeared once the sample reached 84° C. (see FIG. 13).

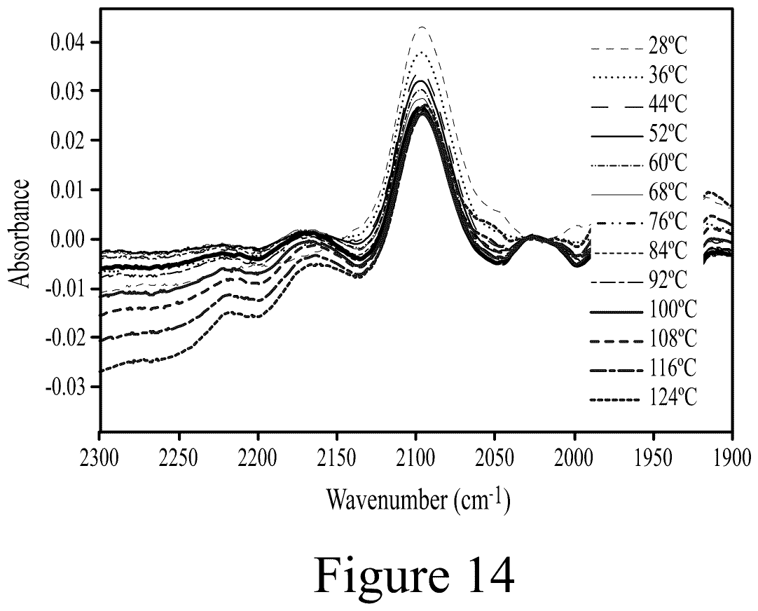

A porous liquid (PL) was then made by suspending activated Cu(I)-COF-301@PDMS-MA in liquid PDMS (dried at 200° C.), and the Cu(I) site activity was confirmed by the appearance of the same CO—Cu(I) stretch at 2093 cm 1 in DRIFTS (see FIG. 12). The kinetics of CO adsorption/desorption were clearly affected by the PDMS matrix, with the CO—Cu(I) stretch intensity slowly increasing during an hour of exposure to CO. Likewise, the CO—Cu(I) stretch never fully disappeared upon heating to 124° C., at least not on the time scale of the experiment (see FIG. 14). The results indicate the PDMS (i.e., second polymer) has a strong influence on gas diffusion rates.

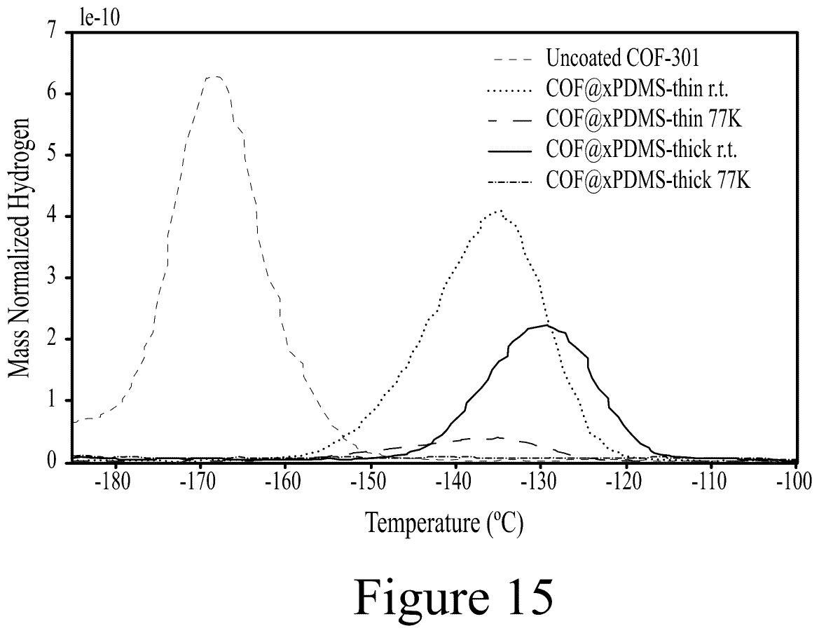

Temperature programmed desorption (TPD). Here TPD was used to study general physisorption and associated kinetic phenomenon in these coated COF materials. For this work, H₂ was primarily used, which typically requires cryogenic temperatures for appreciable gas loading in COF materials. FIG. 15 represents a series of experiments illustrating the desorption of H₂ from uncoated as well as ‘thin’ and ‘thick’ coated colloidal COF-301. First, the sample was dosed with 1.3 bar H₂ at room temperature for 10 minutes, after which it was quenched in liquid N₂. The head space was evacuated until the H₂ signal reached a baseline pressure of 10⁻⁸ Torr. The temperature was then ramped at 15° C./min while under ultra-high vacuum. Under these conditions, peak desorption (Tₘₐₓ) occurred near −170° C. The results were identical if the uncoated sample was dosed at 77K for 10 minutes instead of at room temperature.

H₂ desorbed from the crosslinked COF-301@x ‘thick’ PDMS-MA material near Tₘₐₓ=−130° C., about 40° C. higher than the uncoated material (see FIG. 15). For the thin coated material, H₂ desorbed near Tₘₐₓ=−135° C. However, COF-301@x ‘thick’ PDMS-MA did not adsorb any appreciable amount of H₂ during a 10 minute dose at 77 K. This unique behavior indicates that H₂ diffusion through the crosslinked PDMS-MA coating was limited or slow below its glass transition temperature (T_{g}), with the glassy PDMS-MA presenting a barrier to diffusion on the time scale of this experiment. Sorption kinetics were also affected by the crosslinked PDMS-MA coating thickness. While the thick coated material did not adsorb any H₂ during a 10 minute 77K dose, the thin coated material adsorbed ˜10% of the H₂, it would otherwise adsorb when dosed above its Ts (see FIG. 15).

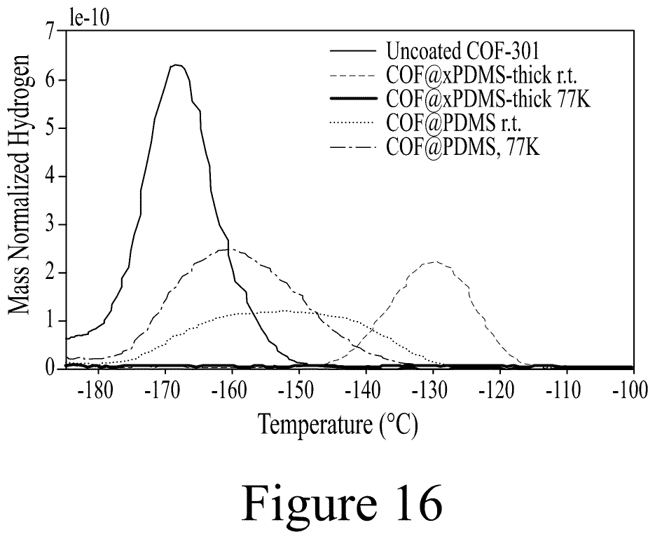

Quite interestingly, the addition of the crosslinking agent proved instrumental in creating a barrier for H₂ diffusion. COF-301@PDMS-MA (with no added crosslinker) readily adsorbed H₂ during a 10 minute dose at 77 K, similar to the uncoated material, with peak desorption occurring near −150° C. (see FIG. 16).

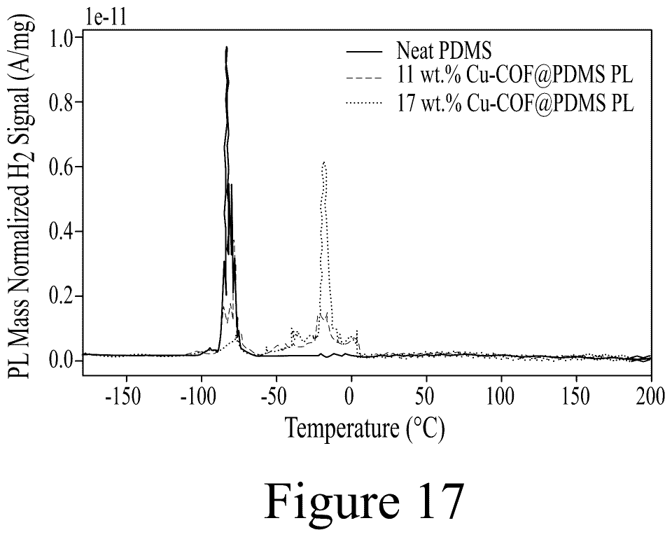

The temperature of H₂ desorption was further shifted in PLs made from 11 wt. % and 17 wt. % Cu(I)-COF@PDMS-MA suspended in liquid PDMS. H₂ desorption was observed to peak near Tₘₐₓ=−20° C. in these PL samples (see FIG. 17), indicative of how the PDMS matrix (i.e., the second polymer) significantly impacts gas diffusion from the COF pores. Controlling the temperature at which gas desorbs from COF-based materials is critical in determining their viability in different gas storage and separation applications. While previous efforts have mostly focused on thermodynamic controls, these results indicate that both the coating as well as the PL matrix may provide a unique handle for tuning gas sorption kinetics by using a combination of the crosslinking density of the coating and/or the melting and glass transition temperatures of the PL matrices. Many opportunities exist to further optimize these COF/polymer hybrid materials, including optimization of coating thicknesses and COF-loading in PLs.

Additional examples: In some embodiments of the present disclosure, a coating of a framework and/or some other porous sorbent materials such as carbon and silicon based, can also be utilized for gas purification and separation. In these cases, one or more gases of interest, e.g., a contaminate gas may be adsorbed inside the polymer coated sorbent material, while one or more other gases is excluded. For example, a water vapor/hydrogen gas mixture may be treated such that the hydrogen gas is preferentially adsorbed within a hydrophobic polymer coated sorbent, to the exclusion of the water. So, in some embodiments of the present disclosure, materials in a gaseous state that may be preferentially adsorbed in this manner include hydrogen, CO₂, ammonia, and/or a noble gas (e.g., He, Ar, Ne, Xe). Examples of materials in a gaseous state that may be excluded from adsorption include water and volatile organics. In some embodiments of the present disclosure, a coating may be utilized to remove the requirement for the coated matrix to be stored under an inert atmosphere. In some embodiments of the present disclosure, a coating may be utilized to remove the requirement for the coated matrix to be stored under dry conditions. In some embodiments of the present disclosure, a polymer used for a coating could be of a hydrophilic or hydrophobic nature to achieve a desired separation.

### Experimental

General. Monomethacryloxypropyl terminated polydimethylsiloxane, 10 cSt (PDMS-MA) was purchased from Gelest. Tetrakis(4-aminophenyl) methane was purchased from Tokyo Chemical Industry and 2,5-dihydroxy terephthalaldehyde was purchased from A-Chem Block. Polydimethylsiloxane, trimethylsiloxy terminated (M.W. 6000) was purchased from Alfa Acsar. All other chemicals were purchased from Sigma Aldrich. 1H NMR (400 MHZ) spectra were recorded on a Bruker Avance III HD NanoBay NMR spectrometer. UV-Vis measurements were performed on a Varian 50 Conc UV-Visible Spectrophotometer.

Atom Transfer Radical Polymerization (ATRP) of Bottlebrush PDMS. The following procedure describes a generic PDMS brush polymerization using ATRP. A Schlenk flask was loaded with a stir bar, 2 mg (0.02 mmol) of CuCl₂ g (2 mmol) of PDMS-methacrylate (PDMS-MA), 0.4 mL of dry acetonitrile, and 3.6 mL of dry 1,4-dioxane. After the heterogenous mixture was sparged with N₂ for 20 minutes, 5.4 μL of N₂ sparged tris[2-(dimethylamino)ethyl]amine (Me₆TREN) (0.02 mmol) was injected and the mixture was sonicated for 20 minutes to ensure full dissolution of the Cu catalyst. A T₀ aliquot was taken, after which 15 μL of a 10 v % stock solution of N₂ sparged ethyl α-bromoisobutyrate initiator (EBriB, 0.01 mmol) in dioxane was injected. The polymerization was stirred at room temperature for 24 hours, with aliquots taken systematically to monitor polymer growth. Integration of the ¹H NMR vinyl peaks over the course of the reaction indicated 70% conversion was achieved after 24 hours.

Colloidal COF Synthesis. Colloidal COF-301 was synthesized and purified. 80 mg (0.21 mmol) of tetrakis(4-aminophenyl) methane and 80 mg (0.48 mmol) of 2,5-dihydroxyterephthalaldehyde were added to a bomb flask and dissolved in 50 mL dry acetonitrile. The mixture was sparged with N₂ for 10 minutes, and then 10 μL of trifluoroacetic acid was injected. After sparging the mixture another 5 minutes, the reaction was stirred at 120° C. for 72 hours. The COF colloid was purified with three cycles of centrifugation, decanting, and resuspension/stirring in acetonitrile.

Polymeric initiator synthesis. The polymeric initiator molecule was synthesized via a radical addition-fragmentation chain-transfer (RAFT) polymerization. A Schlenk flask was charged with 1.0 g (3.6 mmol) 2-(2-bromoisobutyryloxy)ethyl methacrylate (BIEM), 63 mg (0.5 mmol) 4-vinyl benzaldehyde (VBA), 31 mg (0.09 mmol) 2-cyano-2-propyl dodecyltrithiocarbonate, 5 mg (0.03 mmol) azobisisobutyronitrile (AIBN), and 1 mL dimethylformamide. After three freeze-pump-thaw cycles, the reaction was heated at 60° C. for 40 hours. P(BIEM-r-VBA) was purified by thrice precipitating into 20 mL of cold methanol, collecting by centrifugation, and resuspending in 2 mL of tetrahydrofuan. Finally, it was dried on a Schlenk line vacuum overnight at 60° C. ¹H NMR was used to estimate the ratio of initiating (Br) to anchoring (aldehyde) sites as 94:6.

COF-301@PDMS-MA Synthesis. P(BIEM-r-VBA) was first tethered to the COF-301 surface via a condensation reaction. 20 mg of P(BIEM-r-VBA) was added to 100 mg of colloidal COF suspended in 30 mL of acetonitrile. 10 μL of trifluoroacetic acid was injected and the reaction was stirred at 60° C. for 1 hour. The P(BIEM-r-VBA)-coated COF was purified of acid catalyst and excess unreacted polymeric initiator with three centrifugation, decanting, and resuspension cycles in acetonitrile. Surface-initiated ATRP (SI-ATRP) was then conducted to grow uniform PDMS-MA coatings around the COF colloids by adding 3 mg (0.03 mmol) CuCl, 3 g PDMS methacrylate (3 mmol), and 50 mg (0.25 mmol) ethylene glycol dimethacrylate to a Schlenk flask. 100 mg of COF-301@initiator suspended in 0.6 mL acetonitrile and 5.4 mL dioxane was added to the solution. The mixture was sparged with N₂ for 30 minutes and sonicated for 10 minutes. 8 μL (0.03 mmol) of N₂ spaged Me₆TREN was injected, and the reaction was stirred at room temperature for up to 24 hours. The material was purified with five centrifuge, decanting, resuspension cycles in dichloromethane. The material was stored in dichloromethane but dried on a Schlenk line vacuum for 48 hours at 90° C. and further ‘activated’ for 2 hours at 200° C. under ultra-high vacuum prior to analysis with temperature programmed desorption. The success of the coating procedure was verified through TEM imaging and energy-dispersive spectroscopy (EDS) mapping of Si atoms unique to the polymeric coating (vide infra).

Cu loading into COF-301@PDMS-MA. 100 mg of purified COF-301@PDMS-MA was stirred with 140 mg Cu(II) formate in 50 mL of a 1:1 dichloromethane:methanol solution for 24 hours at 40° C. The Cu(II)-COF-301@PDMS-MA was purified with three centrifuge, decanting, resuspension cycles in methanol. Prior to activation, the Cu loaded COF colloids were collected by centrifugation and dried overnight at room temperature on a Schlenk line vacuum to yield a brown powder. Cu(II) formate in the COF could then be efficiently converted to open Cu(I) sites by activation at 200° C. under ultra-high vacuum for 2 hours, yielding a black powder. The presence and location of Cu in the COF was confirmed with TEM-EDS imaging (vide infra).

Porous Liquid Synthesis. Prior to synthesis of any porous liquids, both the Cu-COF-301@PDMS-MA and the PDMS (Mw ˜ 6000 g/mol) were dried and activated at 200° C. under ultra-high vacuum for 3 hours. The desired wt. % of Cu-COF@PDMS-MA was then added to the liquid PDMS in a He glovebox and stirred until suspended. The porous liquid was again dried for 1 hour at 200° C. under ultrahigh vacuum prior to further study.

Polymer molecular weight determination. Polymer samples were dissolved in HPLC grade tetrahydrofuran (THF) (˜1 mg/mL), filtered through alumina to remove Cu catalyst, and then filtered through a 0.45 μm PTFE filter. Size exclusion chromatography was then performed on a PL-Gel 300×7.5 mm (5 μm) mixed C column using an Agilent 1200 series autosampler, inline degasser, and diode array detector set to monitor absorbance at 254 nm. The column and detector temperatures were 35° C. HPLC grade THF was used as eluent (1 mL/min). Linear polystyrene standards were used for calibration.

Transmission Electron Microscopy (TEM). Scanning transmission electron microscopy (STEM) images and the corresponding energy dispersive x-ray spectroscopy (EDS) hypermaps were collected using an FEI Talos F200X operated at 200 kV. Samples were suspended in hexane and dropped onto a 300-mesh gold grid with lacey Formvar/carbon (Ted Pella, 060821). Elemental EDS maps were both collected (acquisition time 5 minutes) and processed by standard methods using Bruker ESPRIT software.

Temperature Programmed Desorption (TPD). TPD measurements were performed on a calibrated, custom-built system equipped with a Stanford Research Systems RGA 100, capable of measuring m/z=1-100 amu. M/z range of 1-50 amu was used for each experiment. Each sample contained 2-5 mg of active COF material and was activated at 200° C. prior to analysis. The samples were dosed with 1.3 bar H₂ for 10 minutes at room temperature (porous liquids were stirred during dosing), followed by a liquid N₂ quench and evacuation of the head space until the H₂ signal reached a baseline pressure of 10⁻⁸ Torr. A type K thermocouple was employed to monitor the temperature, and the samples were heated at 15° C./min unless otherwise noted. Experimental parameters were controlled via a Lab View interface that is connected to the RGA, heating system, and pressure gauges. The output signal from the mass spectrometer was divided by the total sample mass to get a normalized signal.

Diffuse Reflectance Infrared Fourier Transform Spectroscopy (DRIFTS). DRIFTS measurements were performed in a Thermo Scientific Nicolet iS50 FT-IR spectrometer equipped with a Harrick Scientific Praying Mantis reaction chamber. Unless otherwise noted, gas flow was set to 100 sccm. The samples were pre-treated at 200° C. under ultra-high vacuum for 3 hours. After cooling, the samples were sealed in an inert environment. The reaction chamber was purged with He at 100 sccm for ca. 10 minutes after loading the sample in an inert environment. A background spectrum was then collected. The Cu-COF@PDMS-MA, neat PDMS, and Cu-COF@PDMS-MA porous liquid were each exposed to 10% CO (CO/He) mixture for 30 minutes (Cu-COF@PDMS-MA, neat PDMS) or 1 hour (Cu-COF@PDMS-MA porous liquid) at room temperature The samples were then purged with He for 40-60 minutes to remove any free CO before collecting spectrum at a ramp rate of 5° C./min.

Physisorption Measurements. Isotherms were collected on a Micromeritics ASAP 2020. Each sample was degassed at 200° C. prior to analysis and transferred to the physisorption instrument without air exposure. CO₂ isotherms were collected at 0° C. with a 30 second equilibration time. A DFT slit-pore model was used to extract pore size distributions.

X-Ray Diffraction (XRD). XRD measurements were performed on a PANalytical PW3040 X-Ray Diffractometer using Cu Kα (λ=1.54 Å) radiation. The scan rate was 2º/min, with a current of 40 mA and a voltage of 45 kV.

Differential Scanning calorimetry. The glass transition temperatures were obtained with a TA Instruments DSC 25 equipped with a Discovery liquid N₂ pump allowing a minimum sampling temperature of −150° C. The system was calibrated at a given temperature ramp using an indium reference sample prior to sample measurements. The samples were heated at a 10° C./min ramp rate with a 50 mL/min N₂ flow through the cell and 307 mL/min base purge.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

### EXAMPLES

Example 1. A composition comprising: an organic framework material having an internal volume and an outer surface; and a first polymer covalently bonded to at least a portion of the outer surface, wherein: the covalently bonded first polymer has a glass transition temperature (T_{g}) between about −130° C. and about +180° C., the composition is capable of reversibly adsorbing and desorbing H₂ when the composition is at a temperature greater than or equal to the T_{g}, and the composition is capable of storing H₂ within the internal volume when the composition is at a temperature less than T_{g}.

Example 2. The composition of Example 1, wherein T_{g} is between about −80° C. and about +50° C.

Example 3. The composition of either Example 1 or Example 2, wherein the organic framework material comprises at least one a covalent organic framework (COF) or a metal organic framework (MOF).

Example 4. The composition of any one of Examples 1-3, wherein the COF includes a chelated first row transition metal (Mt) comprising at least one of Sc, Ti, V, Cr, Mn, Fe, Co, Ni, Cu, or Zn.

Example 5. The composition of any one of Examples 1-4, wherein: the COF comprises a first structure comprising at least one of

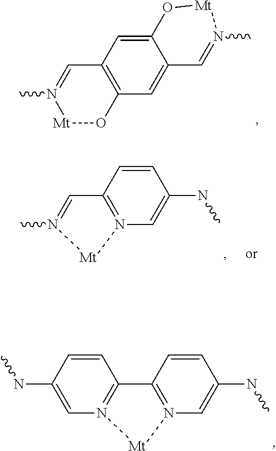

and [symbol] represents a covalent bond.

Example 6. The composition of any one of Examples 1-5, wherein Mt is Cu. Cu(I).

Example 7. The composition of any one of Examples 1-6, wherein the Cu is

Example 8. The composition of any one of Examples 1-7, wherein the COF comprises a second structure comprising at least one of

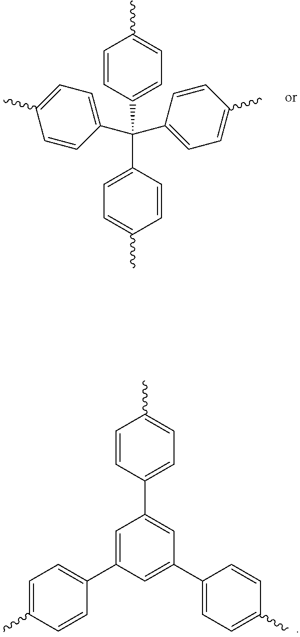

Example 9. The composition of any one of Examples 1-8, wherein the first polymer comprises at least one of an alkyl chain, a siloxane, or an ethylene oxide group.

Example 10. The composition of any one of Examples 1-9, wherein the first polymer comprises at least one of an acrylate, methacrylate, or styrene.

Example 11. The composition of any one of Examples 1-10, wherein the acrylate or methacrylate further comprises an alkyl chain between 1 and 20, inclusively.

Example 12. The composition of any one of Examples 1-11, wherein the alkyl chain is between 4 and 8 carbon atoms, inclusively.

Example 13. The composition of any one of Examples 1-12, wherein the first polymer comprises at least one of a poly(alkyl acrylate), a poly(alkyl methacrylate), a polydimethylsiloxane acrylate, a polydimethylsiloxane methacrylate, a polyethylene glycol acrylate, or a polyethylene glycol methacrylate.

Example 14. The composition of any one of Examples 1-13, comprising a third structure

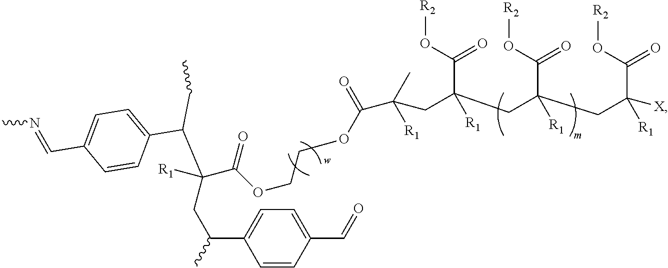

wherein: w is between 0 and 20, inclusively, m is between 1 and 500, inclusively, X comprises a halogen, R₁ comprises a methyl group or H, and R₂ comprises at least one of an alkyl chain, a siloxane, or an ethylene oxide group.

Example 15. The composition of any one of Examples 1-14, wherein w is between 1 and 8, inclusively.

Example 16. The composition of any one of Examples 1-15, wherein m is between 5 and 50, inclusively.

Example 17. The composition of any one of Examples 1-16, wherein the halogen comprises at least one of Br, Cl, or I.

Example 18. The composition of any one of Examples 1-17, wherein the alkyl chain in R₂ is between 1 and 20 carbon atoms, inclusively.

Example 19. The composition of any one of Examples 1-18, wherein, R₂ is between 4 and 8 carbon atoms, inclusively.

Example 20. The composition of any one of Examples 1-19, wherein: R₂ comprises at least one of

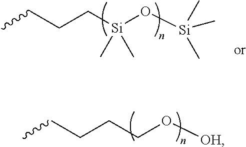

and n is between 1 and 500, inclusively.

Example 21. The composition of any one of Examples 1-20, wherein, n is between 5 and 50, inclusively.

Example 22. The composition of any one of Examples 1-21, further comprising a fourth structure

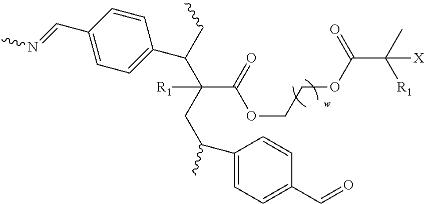

wherein: w is between 0 and 20, inclusively, X comprises at least one of Cl, Br, or I, and R₁ comprises a methyl group or H.

Example 23. The composition of any one of Examples 1-22, wherein w is between 1 and 8, inclusively.

Example 24. The composition of any one of Examples 1-23, wherein the COF has an average pore size between about 1 Å and about 40 Å.

Example 25. The composition of any one of Examples 1-24, wherein the average pore size is between about 4 Å and about 25 Å.

Example 26. The composition of any one of Examples 1-25, wherein the COF has an average surface area above about 400 m²/g.

Example 27. The composition of any one of Examples 1-26, wherein the average surface is between about 50 m²/g and about 3000 m²/g, inclusively.

Example 28. The composition of any one of Examples 1-27, wherein the COF forms a particle having an average diameter between about 10 nm and about 10 μm, or between about 50 and about 400 nm.

Example 29. The composition of any one of Examples 1-28, wherein the COF has an H₂ loading above about 0.01 g H₂/g.

Example 30. The composition of any one of Examples 1-29, wherein the H₂ loading is between about 0.001 g H₂/g and about 0.04 g H₂/g.

Example 31. The composition of any one of Examples 1-30, further comprising: a second polymer comprising at least one of a polydimethylsiloxane, a polyethyleneimine, a polyethylene glycol, a poly(alkyl acrylate), or a poly(alkyl methacrylate), wherein: the COF is immersed in the second polymer, and the second polymer is characterized by a second T_{g} between about −130° C. and about +180° C.

Example 32. The composition of any one of Examples 1-31, wherein the second T_{g} is between about −80° C. and about +50° C.

Example 33. The composition of any one of Examples 1-32, wherein the MOF includes a chelated first row transition metal (Mt) comprising at least one of Sc, Ti, V, Cr, Mn, Fe, Co, Ni, Cu, or Zn.

Example 34. The composition of Example 33, wherein: the MOF comprises a first structure comprising at least one of

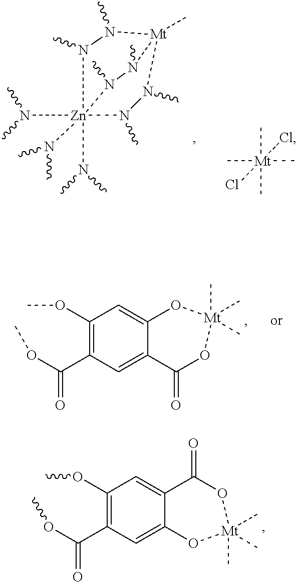

[symbol]

represents a covalent bond, and [symbol] represents a coordinate bond to Mt.

Example 35. The composition of either Example 33 or Example 34, wherein Mt is at least one of Ni or Co.

Example 36. The composition of any one of Examples 33-35, wherein Mt is at least one of Ni(II) or Co(II).

Example 37. The composition of any one of Examples 33-36, wherein the MOF comprises a second structure comprising at least one of

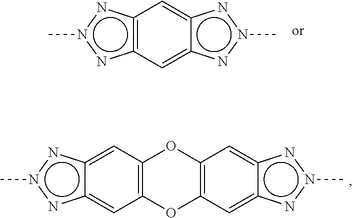

and [symbol] represents a coordinate bond to Mt.

Example 38. The composition of any one of Examples 33-37, wherein the first polymer comprises at least one of an alkyl chain, a siloxane, or an ethylene oxide group.

Example 39. The composition of any one of Examples 33-38, wherein the first polymer comprises at least one of an acrylate, methacrylate, or styrene.

Example 40. The composition of any one of Examples 33-39, wherein the acrylate or methacrylate further comprises an alkyl chain between 1 and 20, inclusively.

Example 41. The composition of any one of Examples 33-40, wherein the alkyl chain is between 4 and 8 carbon atoms, inclusively.

Example 42. The composition of any one of Examples 33-41, wherein the first polymer comprises at least one of a poly(alkyl acrylate), a poly(alkyl methacrylate), a polydimethylsiloxane acrylate, a polydimethylsiloxane methacrylate, a polyethylene glycol acrylate, or a polyethylene glycol methacrylate.

Example 43. The composition of any one of Examples 33-42, comprising a third structure

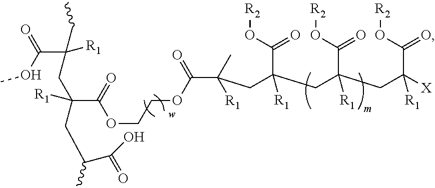

wherein: w is between 0 and 20, inclusively, m is between 1 and 500, inclusively, X comprises a halogen, R₁ comprises a methyl group or H, and R₂ comprises at least one of an alkyl chain, a siloxane, or an ethylene oxide.

Example 44. The composition of any one of Examples 33-43 wherein w is between 1 and 8, inclusively.

Example 45. The composition of any one of Examples 33-44, wherein m is between 5 and 50, inclusively.

Example 46. The composition of any one of Examples 33-45, wherein the halogen comprises at least one Br, Cl, or I.

Example 47. The composition of any one of Examples 33-46, wherein the alkyl chain in R₂ is between 1 and 20, inclusively.

Example 48. The composition of any one of Examples 33-47, wherein R₂ is between 4 and 8 carbon atoms, inclusively.

Example 49. The composition of any one of Examples 33-48, wherein the structure in R₂ comprises

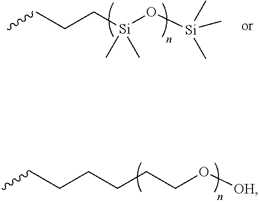

where n is between 1 and 500, inclusively.

Example 50. The composition of any one of Examples 33-49, wherein n is between 5 and 50, inclusively.

Example 51. The composition of any one of Examples 33-50, further comprising a fourth structure

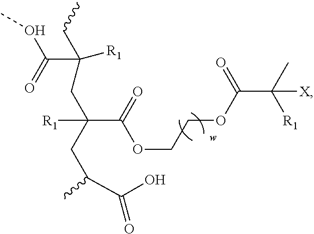

wherein: w is between 0 and 20, inclusively, X comprises at least one of Cl, Br, or I, and R₁ comprises a methyl group or H.

Example 52. The composition of any one of Examples 33-51, wherein w is between 1 and 8, inclusively.

Example 53. The composition of any one of Examples 33-52, wherein the MOF has an average pore size between about 1 Å and about 40 Å.

Example 54. The composition of any one of Examples 33-53, wherein the average pore size is between about 4 Å and about 25 Å.

Example 55. The composition of any one of Examples 33-54, wherein the MOF has an average surface area above about 400 m²/g.

Example 56. The composition of any one of Examples 33-55, wherein the average surface is between about 50 m²/g and about 3000 m²/g.

Example 57. The composition of any one of Examples 33-56, wherein the MOF forms a particle having an average diameter between about 10 nm and about 10 μm.

Example 58. The composition of any one of Examples 33-57, wherein the average diameter is between about 50 nm and about 400 nm.

Example 59. The composition of any one of Examples 33-58, wherein the MOF has an H₂ loading above about 0.01 g H₂/g.

Example 60. The composition of any one of Examples 33-59, wherein the H₂ loading is between about 0.001 g H₂/g and about 0.08 g H₂/g.

Example 61. The composition of any one of Examples 33-60, further comprising: a second polymer comprising polydimethylsiloxane, polyethyleneimine, polyethylene glycol, poly(alkyl acrylate), poly(alkyl methacrylate), wherein: the MOF immersed in the second polymer, and the second polymer is characterized by a second T_{g} in a range between about −130° C. and about +180° C.

Example 62. The composition of any one of Examples 33-61, wherein the second T_{g} is between about −80° C. and about +50° C.

Example 63. A method for making a composition, the method comprising:
synthesizing a framework material; synthesizing a first polymer (e.g., “bottlebrush PDMS” from monomethacrylated siloxane monomer by atom transfer radical polymerization (ATRP)); synthesizing a bifunctional linking polymer (e.g., Br containing polymer by radical addition-fragmentation chain transfer (RAFT) polymerization); attaching the bifunctional linking polymer to a surface of the framework material; and attaching the first polymer to the bifunctional linking polymer.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a covalent organic framework (COF) having an internal volume and an outer surface; and
a first polymer covalently bonded to at least a portion of the outer surface, wherein:
the covalently bonded first polymer has a glass transition temperature (T_{g}) between about −130° C. and about +180° C.,
the composition is capable of reversibly adsorbing and desorbing H₂ when the composition is at a temperature greater than or equal to the T_{g}, and
the composition is capable of storing H₂ within the internal volume when the composition is at a temperature less than T_{g}.

2. The composition of claim 1, wherein the COF includes a chelated first row transition metal (Mt) comprising at least one of Sc, Ti, V, Cr, Mn, Fe, Co, Ni, Cu, or Zn.

3. The composition of claim 2, wherein:
the COF comprises a first structure comprising at least one of 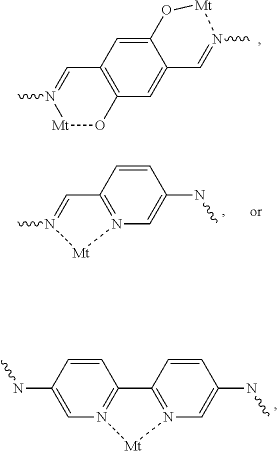
and [symbol]
represents a covalent bond.

4. The composition of claim 2, wherein the COF comprises a second structure comprising at least one of

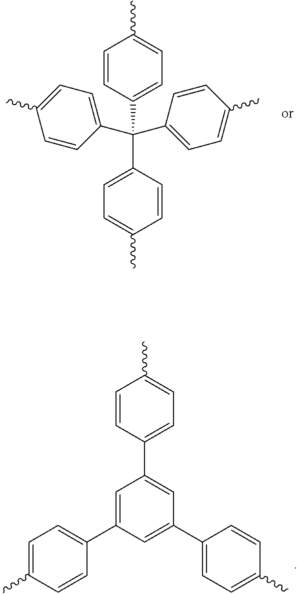

5. The composition of claim 2, wherein the first polymer comprises at least one of an alkyl chain, a siloxane, or an ethylene oxide group.

6. The composition of claim 5, wherein the first polymer comprises at least one of a poly(alkyl acrylate), a poly(alkyl methacrylate), a polydimethylsiloxane acrylate, a polydimethylsiloxane methacrylate, a polyethylene glycol acrylate, or a polyethylene glycol methacrylate.

7. The composition of claim 2, comprising a third structure that includes the first polymer defined by 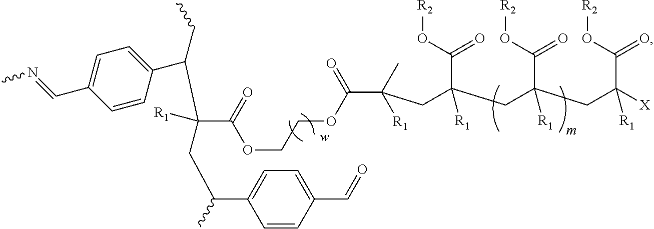
wherein:
w is between 0 and 20, inclusively,
m is between 1 and 500, inclusively,
X comprises a halogen,
R₁ comprises a methyl group or H,
and R₂ comprises at least one of an alkyl chain, a siloxane, or an ethylene oxide group.

8. The composition of claim 7, wherein:
R₂ comprises at least one of 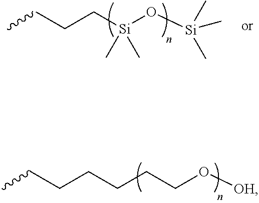
and
n is between 1 and 500, inclusively.

9. The composition of claim 7, further comprising a fourth structure 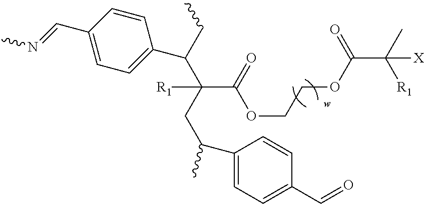
wherein:
w is between 0 and 20, inclusively,
X comprises at least one of Cl, Br, or I, and
R₁ comprises a methyl group or H.

10. The composition of claim 1, wherein the COF has an average pore size between about 1 Å and about 40 Å.

11. The composition of claim 1, wherein the COF has an average surface area above about 400 m²/g.

12. The composition of claim 1, wherein the COF forms a particle having an average diameter between about 10 nm and about 10 μm.

13. The composition of claim 1, wherein the COF has an H₂ loading above about 0.01 g H₂/g.

14. The composition of claim 1, further comprising:
a second polymer comprising at least one of a polydimethylsiloxane, a polyethyleneimine, a polyethylene glycol, a poly(alkyl acrylate), or a poly(alkyl methacrylate), wherein:
the COF is immersed in the second polymer, and
the second polymer is characterized by a second T_{g} between about −130° C. and about +180° C.

15. A composition comprising:
a metal organic framework (MOF) having an internal volume and an outer surface; and
a first polymer covalently bonded to at least a portion of the outer surface, wherein:
the covalently bonded first polymer has a glass transition temperature (T_{g}) between about −130° C. and about +180° C.,
the composition is capable of reversibly adsorbing and desorbing H₂ when the composition is at a temperature greater than or equal to the T_{g}, and
the composition is capable of storing H₂ within the internal volume when the composition is at a temperature less than T_{g}.

16. The composition of claim 15, wherein:
the MOF comprises a first structure comprising at least one of 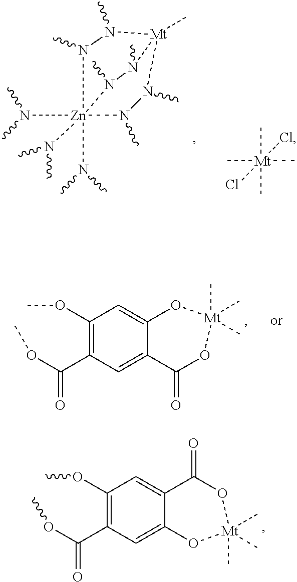 [symbol]
represents a covalent bond, and [symbol]
represents a coordinate bond to Mt.

17. The composition of claim 15, wherein the MOF comprises a second structure comprising at least one of 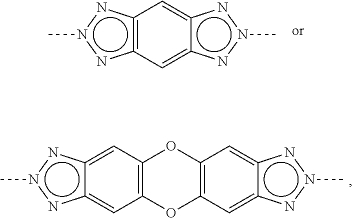
and [symbol]
represents a coordinate bond to Mt.

18. The composition of claim 15, comprising a third structure that includes the first polymer 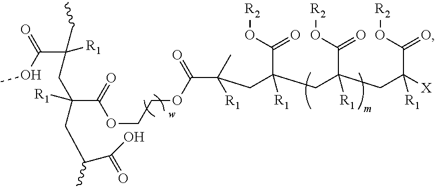
wherein:
w is between 0 and 20, inclusively,
m is between 1 and 500, inclusively,
X comprises a halogen,
R₁ comprises a methyl group or H, and
R₂ comprises at least one of an alkyl chain, a siloxane, or an ethylene oxide group.

19. The composition of claim 18, further comprising a fourth structure 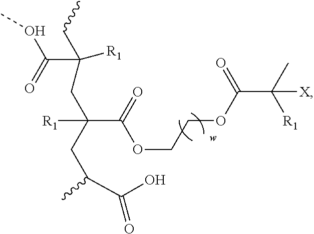
wherein:
w is between 0 and 20, inclusively,
X comprises at least one of Cl, Br, or I, and
R₁ comprises a methyl group or H.

20. A method for making a composition, the method comprising:
synthesizing a framework material;
synthesizing a first polymer;
synthesizing a bifunctional linking polymer;
attaching the bifunctional linking polymer to a surface of the framework material; and
attaching a first polymer to the bifunctional linking polymer.
